(19) United States
(12) Patent Application Publication
(10) Pub. No.: US 2004/0071285 A1
(43) Pub. Date: Apr. 15, 2004

(54) Portable terminal

(76) Inventors: Takayuki Satoh, Yokohama (JP); Tomokazu Ashiwa, Ebina (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/677,430

(22) Filed: Oct. 3, 2003

(30) Foreign Application Priority Data
Oct. 3, 2002 (JP) 2002-290592

(51) Int. Cl. H04M 1/00; H04M 9/00

(52) U.S. Cl. 379/419

(57) ABSTRACT

In these years, in a foldable portable telephone, such a technology for displaying information such as a remaining amount of a battery, the number of received mails and so on, on LCD (sub liquid crystal) which is located on the back surface has been developed, but, for example, in order to take a look at a content of a received mail, there is a necessity to carry out an operation such as taking the trouble to open the housing, and a study regarding usability has not bee carried out sufficiently.

In order to solve the above-described problem, provided is a portable terminal in which a first housing and a second housing, each of which has a front surface and a back surface which is disposed so as to be opposed to the front surface, are foldable through a hinge part, and are foldable in such a manner that the front surface of the first housing and the front surface of the second housing face to each other, and it further has a display part which is located on the back surface of the first or the second housing, and a control part which controls to switch a screen display of the display part in case that a predetermined signal was received.

### FIELD OF THE INVENTION

This invention relates to a portable terminal such as, for example, a portable telephone, PHS, PDA (Personal Digital Assistant), PCS (Personal Communication Service), PC (Personal Computer) and so on.

### BACKGROUND OF THE INVENTION

In these years, in a foldable portable terminal, such a terminal that, in addition to LCD (main liquid crystal) which was formed on a front surface of a housing thereof, LCD (sub liquid crystal) which is usable even in a folded state was formed on a back surface thereof has been developed. In addition, the front surface is a surface which is exposed in a state that a foldable portable telephone was opened, and the back surface is a surface which is exposed in a folded state (closed state), and a surface of a back side of the front surface (e.g., JP-A-2002-111816 gazette).

Also, in LCD (sub liquid crystal) arranged on aback surface, such a technology that information such as a power, the number of mails arrived and so on has been developed (e.g., JP-A-11-265254 gazette).

On one hand, in a JP-A-2001-186396 gazette, disclosed is a structure which is not one wherein a liquid crystal display parts were formed on both surfaces of a front surface and a back surface but, which, in order to make it usable even in such a state that the main liquid crystal formed on the front surface was folded, enabled folding toward an opposite side to a normally folded side so as for the main liquid crystal to be exposed.

In the same manner, in a JP-A-2001-320463 gazette, disclosed is a structure which makes the main it usable by having the main liquid crystal exposed in the folded state, by folding after 180 degree rotating in the horizontal direction the housing on the front surface of which, the main liquid crystal was formed, against a hinge part.

### SUMMARY OF THE INVENTION

However, in a typical portable terminal as disclosed in the above-described publicly known examples and so on, in order to take a look at a content of a mail received, there is a necessity to conduct operations such as taking the trouble to open the housing, and changing a screen to an in-box in an E-mail mode, and a sufficient study was not conducted with regard to usability of quickly and easily reading the content of the received mail. This is not limited to the foldable type portable terminal but also applicable to another portable terminal.

Also, any one of the publicly known examples does not have a concept of effectively utilizing the sub liquid crystal which was disposed separately from the main liquid crystal, and a study is not conducted at all with regard to usability at the time of receiving a mail in case of using the sub liquid crystal.

Also, in the same manner as in the E-mail, in any one of the publicly known examples, a sufficient study is not conducted with regard to usability at the time of telephone arrival using the sub liquid crystal.

In addition, in the JP-A-2001-186396 gazette and the JP-A-2001-320463 gazette, both of them disclose a structure which becomes usable by having the main liquid crystal which was formed on the front surface exposed in the folded state, but this simply relates to use of the main liquid crystal and does not relates to the sub liquid crystal which was formed on the back surface. Also, in case of these portable terminals, in order to have the main liquid crystal exposed, unlike a folded state in case of normally carrying around (the folded (closed) state in this embodiment), there was a necessity to take the trouble to have the housing reversed or rotated.

Therefore, as described above, in any one of the above-described publicly known examples, a sufficient study was not conducted with regard to a view point of usability at the time of receiving a mail, for example, a point of taking a look at the received mail quickly and easily. In particular, a sufficient study was not conducted with regard to effectively utilizing the sub liquid crystal which was disposed separately from the main liquid crystal.

Also, usability at the time of arrival of a call using a sub liquid crystal has not been studied sufficiently,

Consequently, this invention aims to improve usability at the time of receiving a mail or at the time of receiving a telephone. In particular, it aims to realize effective utilization of the sub liquid crystal at the time of receiving a mail or at the time of receiving a telephone.

This invention is, in order to accomplish the above-described aims, one which was configured as described in claims.

### BRIEF DESCRIPTION OF THE DRAWINGS

The invention, together with further advantages thereof, may best be understood by reference to the following description taken in conjunction with the accompanying drawings in which:

FIG. 1 is a conspectus view of a portable telephone of a first embodiment;

FIG. 2 is a structural block diagram of the first embodiment;

FIG. 3 is a process flow chart of the first embodiment;

FIG. 4 is a storage format table of pickup image information in the first embodiment;

FIG. 5 shows an example of a display screen of the first embodiment;

FIG. 6 is a process flow chart of a second embodiment;

FIG. 7 shows an example of a display screen of the second embodiment;

FIG. 8 is a process flow chart of a third embodiment;

FIG. 9 shows an example of a display screen of the third embodiment;

FIG. 10 is a process flow chart of a fourth embodiment;

FIG. 11 shows an example of a display screen of the fourth embodiment;

FIG. 12 shows an example of a layout of a sub operation key 107;

FIG. 13 is a view showing a shape of the sub operation key;

FIG. 14 shows an example of display screen transition of a sub display part 104 at the time of a normal state other than a camera mode; and

FIG. 15 is a view explaining a definition of a back surface or a side surface of a housing.

### DETAILED DESCRIPTION OF THE EMBODIMENTS

Hereinafter, embodiments of this invention will be described by use of the drawings. In addition, in the following drawings, the same reference numerals indicate the same structural parts.

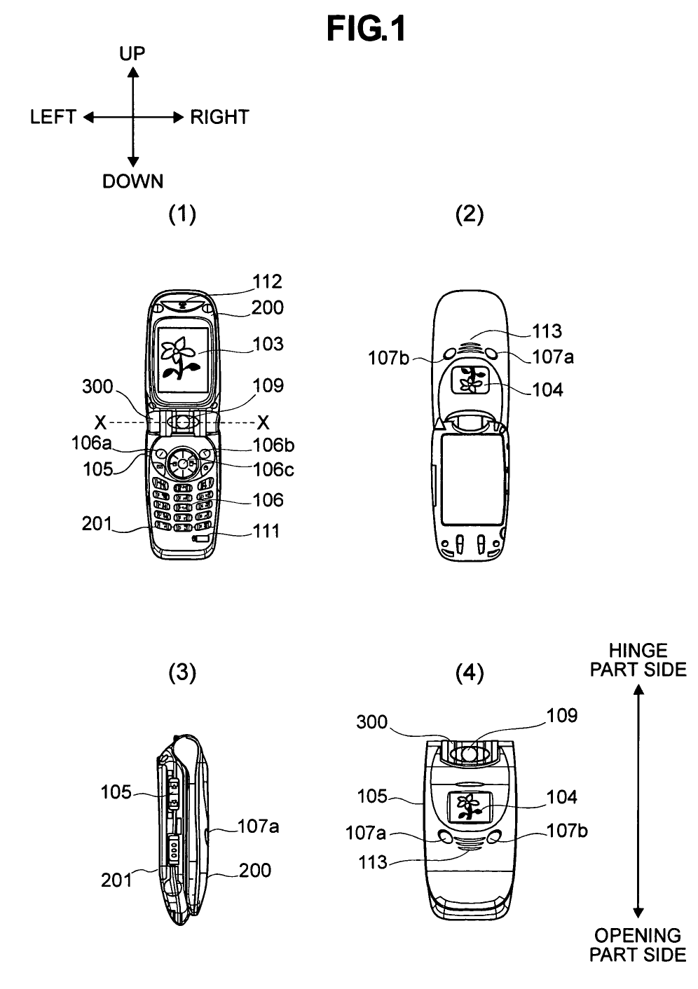

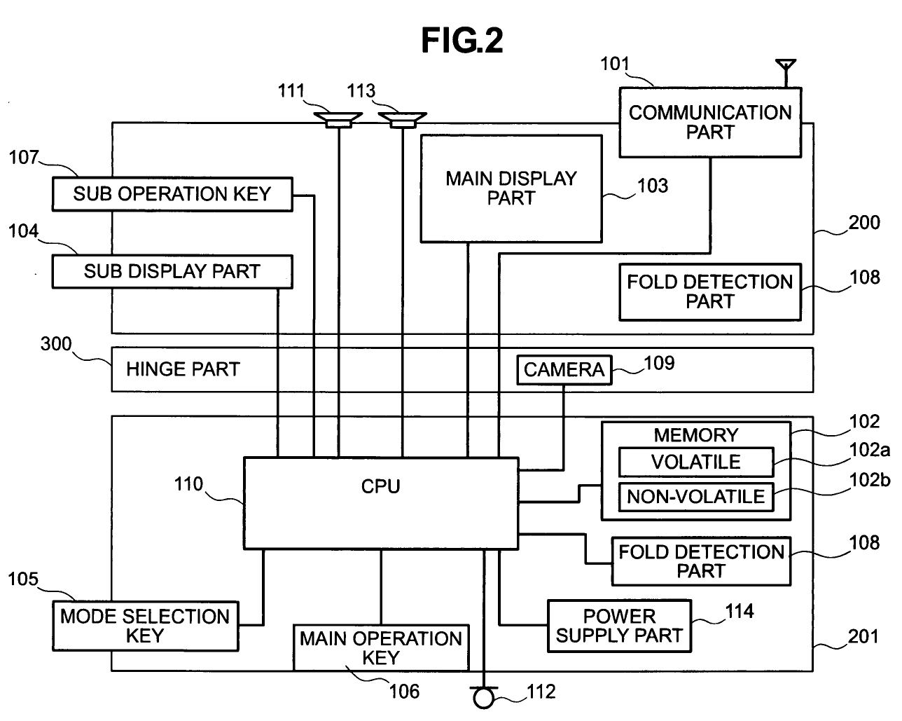

FIG. 1 shows a conspectus view of a portable telephone of this embodiment (first embodiment), and FIG. 2 is a structural block diagram of this embodiment. Also, FIG. 1(1) shows a view of a housing, and FIG. 1(2) shows a view of the housing which was viewed from a back surface thereof, and FIG. 1(3) shows a view of the housing which was viewed from a side surface thereof, and FIG. 1(4) shows a view of the housing in a folded state, respectively.

Here, in this embodiment, directions of left and right, up and down are defined in a state of taking a look at a portable terminal from a front surface thereof as shown in FIG. 1(1).

Also, a front surface of the housing which configures the portable telephone in this specification is defined to be of a range of vision from a front surface in such a state that the portable telephone was opened as shown in FIG. 1(1), and a back surface thereof is defined to be of a range of vision from a back surface of the front surface in such a state that the portable telephone was opened as shown in FIG. 1(2), and a side surface thereof is defined to be of a range other than the above-described ones.

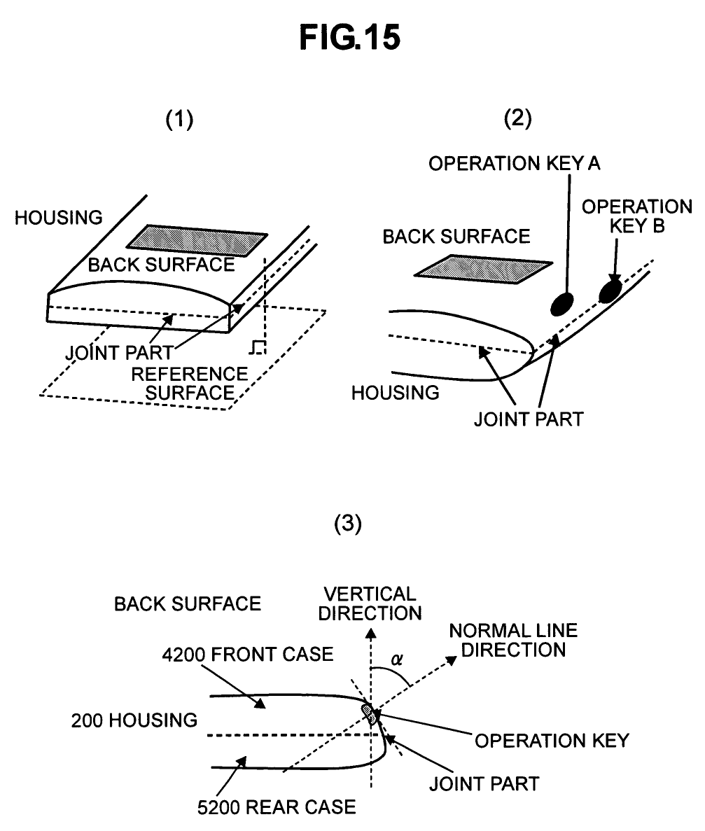

In this regard, however, in a current portable telephone, a streamline shaped housing is adopted, and there are quite a lot of portable telephones in which a boundary line between the front surface, the back surface and the side surface is not clear. For example, as shown in FIG. 15(1), in a portable telephone in which a side surface is approximately 90 degree to a reference surface, by the above-described definitions, it is easily determined that a front surface is of a range of vision from a front surface in such a state that the portable telephone was opened, and a back surface is of a range of vision from a back surface of the front surface in such a state that the portable telephone was opened, and a side surface is of a range other than the above-described ones.

However, as shown in FIG. 15(2), when a surface which is approximately 90 degree to the reference surface is not clear, all surfaces can be viewed from the front surface and the back surface, and also, a boundary line between the front surface and the back surface is not clear.

In this connection, even in a case as described above, it was determined that an operation key which was disposed so as to straddle a joint part for jointing an upper side member and a lower side member of a housing (e.g., an operation key B of FIG. 15(2) etc.), even if can be viewed from the front surface or the back surface, is deemed to be disposed on the side surface.

Also, as shown in FIG. 15(3) which shows an example of a cross sectional view wherein a housing 200 is cut in a surface parallel to a hinge part 300, even in case of an operation key which was viewed from a back surface of the housing 200 and disposed at a position which does not straddle the above-described joint part, it was determined that if an angle (α) which is formed by a normal line direction of a located position of the operation key to a housing surface and a vertical direction in a grounded state of the portable telephone is 45 degree and more, it is deemed to be disposed on a side surface. That is, it was determined that, depending upon a fact that the located position of the operation key is close to either of the back surface or the side surface, it is judged whether it is disposed on the back surface or on the side surface.

On one hand, if it is possible to deem that housings 200, 201 are of an approximately 6 face piece, the front surface, the back surface and the side surface may be defined on the basis of the approximately 6 face piece.

In addition, in each case, in a use state wherein the housing was held, for example, whether it is a range of operable by a thumb, or whether it is a range which is difficult to be mistakenly operated becomes a standard for determining a boundary line of each surface.

Now, the portable telephone shown in FIGS. 1 and 2 of this embodiment, by which usability at the time of being folded was improved, will be described. The portable telephone of this embodiment has two housings 200 and 201 which can be opened and closed, and an image pickup part, for example, an image pickup camera 109. These housings 200 and 201 are of a structure which can be folded around an X-X axis as a turning axis, and connected at a hinge part 300.

The housing 200 has a speaker 111 which outputs a sound at the time of telephone and a main display part 103 which conducts a main display, and has, on a back surface of the main display part 103, a sub display part 104 which conducts a simplified display and a sub operation key 107 (in FIG. 1(2), 107a and 107b). Here, on the main display part 103, displayed are not only operating states such as a power state, an electromagnetic wave strength, a power, a server connection state, unread mails and so on, but also received data such as telephone number inputted, a mail address, a mail sending text and so on, and a motion picture and a still picture, telephone number of a caller at the time when an incoming call was received, a received mail text, a screen of Internet connected and so on. On the sub display part 104, displayed are operating states of the portable telephone, and for example, icons which show a power state, an electromagnetic wave strength, a power, a server connection state, and unread mails are displayed. Also, on the main display part 103 and the sub display part 104, it is possible to display (monitor) information of an image which was picked up by the image pickup camera 109 as a finder at the time of camera operation.

Also, it has a music speaker 113 which is used for reproducing a melody signaling an incoming call, and a music file such as mp3 etc.

On one hand, the housing 201 has a main operation key 106 by which a main input operation is carried out, and a microphone 112 through which a sound is inputted, and a mode selection key 105 for switching image pickup modes of the image pick up camera is disposed thereon. Here, the main operation key 106 is an input part for inputting telephone number and other information, and when used as a typical telephone, it is used for inputting telephone number of other party, and in case of sending a mail etc., character information etc. is inputted through it.

Also, the mode selection key 105 is, for example, a key for switching modes such as a motion picture mode for taking a motion picture, a still picture mode for taking a still picture, a setting mode for carrying out various settings for image pickup, a browsing mode for browsing pictures which ware image-picked up, an edit mode for editing pictures which were image-picked up, and so on. In addition, in this embodiment, formed is a slide key which is slid in upward and downward directions but a dial type key such as jog dial etc. may be formed. In addition, it is configured that the slide key can select the motion picture mode by being slid in the upward direction for a predetermined period of time, and can select the still picture mode by being slid in the downward direction for a predetermined period of time.

CPU 110 operates on the basis of a program which was stored in a memory 102, and controls each part in response to an input from the main operation key 106 and the sub operation key 107.

A power supply part 114 is a battery for driving each component part of the portable telephone.

A fold detection part 108 detects a folding state of the portable telephone, and for example, the housing 200 has a magnet and the housing 201 has a hall device, and opening and closing states are detected on the basis of Hi level or a Low level of the voltage value of the hall device to which magnetic fields were applied by the magnet. In addition, the fold detection part 108 may be one which made use of a sensor or an engagement of concavity and convexity, if the opening and closing states can be detected.

Also, disposed is the memory 102 which stores various data, for example, data and so on of motion pictures and still pictures, and the memory 102 is composed of a volatile memory 102a for storing temporarily and a non-volatile memory 102b for holding a stored state regardless of ON/OFF of a power supply.

Also, disposed is a communication part 101, and through this communication part 101, it becomes possible to use a function for communicating with a switching machine and a server, and a GPS (Global Positioning System) function.

In addition, in the approximately center of the hinge part 300 which connects the housing 200 and the housing 201, disposed is the image pickup camera 109 which can be turned separately from the housings 200 and 201, and by this image pickup camera 109, image pickup of a motion picture and a still picture is conducted.

In the above-described portable telephone of this embodiment, it is tried to improve usability in the closed state by forming the sub operation key 107 together with the sub display part 104 on the back surface. In particular, it is possible to improve usability including the camera operation and so on.

Here, the sub operation key 107 which was disposed so as to improve operability in the closed state, in particular operability in camera shooting will be described in details.

We studied as to which function out of camera shooting functions an exclusive use key is prepared for, on the occasion of carrying out camera shooting in a state that the portable terminal was closed. And, we determined that at least, an activation key for activating a camera function, a shutter key for instructing a start of shooting of image information, a zoom adjustment key for adjusting a size of the image information to be taken and a mode selection key for selecting a mode of a motion picture or a still picture, are prepared as exclusive use keys. In addition, although the activation key and the mode selection key are not necessarily required, by preparing them as exclusive use keys, it becomes possible to set a camera mode in a folded state as it is, without opening the portable terminal. On that account, it becomes effective at the time of quick camera shooting and so on.

Next, we studied a layout of these keys. It is fine if each key is usable in the folded state, but it is impossible to secure sufficient operability and usability simply by disposing them.

On one hand, we are of the thought that, to make use of the sub display part 104 formed on the back surface as a finder in the closed state and to operate in a state of holding the portable telephone in such a manner that keys are depressed by a thumb are stable in case of camera shooting and sufficient usability can be secured, and, judging from that view point, it becomes desirable to dispose the above-described exclusive use keys on the back surface.

However, the portable telephone is normally of a small size and has the sub display part 104 on the back surface so that a regions thereof is limited, and if the above-described 4 keys are all disposed, one key may come close to the other key and a size of a key itself is limited so that it becomes easy to be operated mistakenly. For example, the shutter key is intended to be depressed but, the activation key or the mode selection key is mistakenly depressed, and as a result, the portable telephone returns to an initial camera shooting state and is switched from the still picture mode to the motion picture mode so that it becomes impossible to take an image which is wished to be taken.

Therefore, we made such a structure of the portable telephone of this embodiment that a camera function setting key and an shooting time operation key are disposed without mixing them in the same plane. Here, the camera function setting key is an operation key for conducting setting of a camera function prior to shooting such as the activation key, the mode selection key and so on. And, the shooting time operation key is, after the camera function such as a zoom key, the shutter key and so on was activated or in case that a shooting mode of a motion picture or a still picture can be selected, an operation key for carrying out the camera operation during a period after the mode was selected until shooting is completed.

Furthermore, we, thinking that the camera function setting key is essentially a key which is sufficient to be used once at the beginning and the shooting time operation key is a key which is handled a number of times during a period of shooting, determined to form the shooting time operation key on the back surface and to form the camera function setting key on the side surface. The reason that the shooting time operation key was formed on the back surface is, as described above, that operability on the occasion of utilizing the sub display part 104 formed on the back surface as a finder is good, and that it is possible to depress (operate) a key stably by a thumb in a state that the portable telephone was held. Also, the reason that the camera function setting key was formed on the side surface is, on the occasion of operating the zoom key and the shutter key, to prevent them from being mistakenly operated by a thumb.

In addition, if the shooting time operation key is disposed on the side surface of the housing 200 or the housing 201, a finger for operating the shooting time operation key differs between a case that the housings were held by a right hand and a case that the housings were held by a left hand (e.g., a thumb in case of the right hand, and an index finger in case of the left hand), and therefore, if it was disposed on the back surface of the housing 200 or the housing 201, it is possible to conduct a similar operation between the case that the housings were held by the right hand and the case that the housings were held by the left hand, i.e., an operation by a thumb in each case so that usability is good.

The shooting time operation key carries out only a function which was assigned in advance. It may be formed on the back surface as an exclusive use key but, taking a series of operations which become necessary at the time of camera operation into consideration, it is configured by use of such software that a key function is displayed on a sub display screen and a key which corresponds to that display is selected so that a displayed function is carried out, and it is configured such that shooting which one wants is completed over changing the screen. By this, since a key which was formed on the back surface is not occupied simply with one function, even in a normal standby state other than the time of camera operation, it is possible to realize other function by that key. A detailed embodiment thereof will be described later.

As above, the shooting time operation key is, like the sub operation keys 107a and 107b of FIG. 1(4), disposed on the back surface of the housing 200, and the camera function setting key (the mode selection key 105 in FIG. 1(4)) is disposed on the side surface of the housing 201 without mixing with the shooting time operation key, and thereby, it is possible to prevent such a wrong operation that the camera function setting key, instead of the shooting time operation key, is depressed by mistake, and it is possible to easily operate by a thumb which is the easiest to bring pressure out of five fingers over stabilizing the housings by supporting them by a palm of a hand, and in addition, it is possible to conduct camera shooting without few blurring, so that usability is improved.

In addition, the shooting time operation key is a key which is used after the camera function was activated and a shooting mode such as a motion picture mode or a still picture mode was selected until the shooting is completed, and besides the shutter key, for example, a focus adjustment key for adjusting focus, a shutter speed adjustment key for adjusting shutter speed, a brightness adjustment key for adjusting brightness of image information, or a change key for changing a display screen during a period of camera shooting and so on may be used.

Also, even in a case that it is configured to accept an input of the camera function setting key such as the activation key, the mode selection key and so on, after the camera function was activated and the shooting mode such as the motion picture mode, the still picture mode and so on was selected until the shooting is completed, it is determined that a key such as the activation key, the mode selection key and so on is not included in the shooting time operation key in this specification.

Also, since there is no problem if the camera function setting key such as the activation key, the mode selection key and so on is disposed without mixing with the shooting time operation key such as the shutter key and so on, for example, it may be configured that, by use of an operation key which was disposed on the front surface of the portable telephone, the camera function is activated or the motion picture mode or the still picture mode is switched, and by use of the sub operation key 107 (shooting time operation key) which was disposed on the back surface, the shooting is conducted.

In the meantime, in this embodiment, as shown in FIG. 1(4), it was configured that the sub operation key 107 is disposed on a downside than the sub display part 104 with the hinge part 300 as a standard, and they are used in that physical relationship. That is, it is configured that the sub display part 104 is disposed between the sub operation key 107 and the hinge part 300. Also, in this embodiment, it is displayed in such a manner that a downside of an object of shooting is located at the hinge part side in FIG. 1(1) and that an upside of the object of shooting is located at the hinge part side in FIG. 1(4).

Generally, since the main display part 103 and the main operation key 106 in the opened state, as shown in FIG. 1(1), are used in such a physical relationship that the main operation key 106 is disposed at a downside of the main display part 103, by setting a physical relationship of the sub display part 104 and the sub operation key 107 in the closed state to the above-described structure, for example, in case that after a predetermined input and so on was carried out in the opened state, camera shooting is carried out in the closed state, in case that after camera shooting was carried out in the closed state, a predetermined input and so on is carried out, and so on, it becomes possible to operate without changing a hand which holds the housing 201 (without reversing top and bottom of the housing 201), and operability thereof is improved.

In addition, as shown in a publicly known reference 1, there is such a structure that an operation key is disposed on an under part of the main display part in the same housing, but in this case, there is a necessity to operate with shifting a lower housing upwardly, and when the operation is carried out while holding the lower housing, it becomes an operation which straddles the hinge part so that key depression becomes unstable. Also, in case that there is a camera at the hinge part, the camera is interrupted by a finger and a hand on the occasion of operating a key, and it is not one which realizes an operation of stable camera shooting and so on without changing a hand which holds the housing 201 (without reversing top and bottom of the housing 201) which is mentioned in the embodiment.

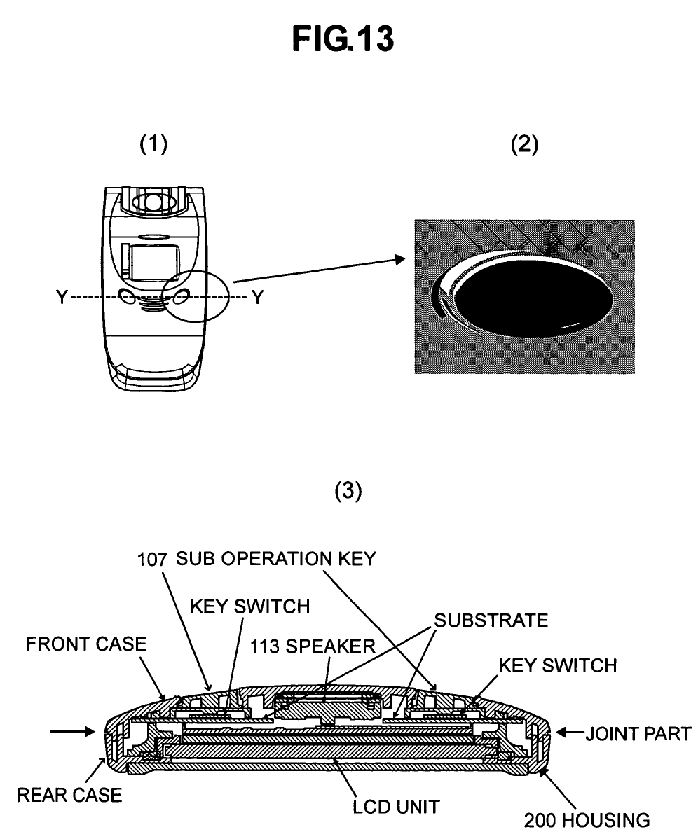

Next, a shape of the sub operation key 107 will be described by use of FIG. 13. FIG. 13(2) is an enlarged view of the operation key 107, and FIG. 13(3) is an example of a cross sectional view in which the housing 200 was cut at a plane which is parallel to the hinge part 300.

Here, as shown in FIG. 13(2), a depression surface of the sub operation key 107 is disposed in such a manner that the sub operation key 107 does not protrude from the back surface of the housing 200. By this, for example, it is possible to prevent such a wrong operation that the sub operation key 107 is mistakenly depressed in case that a portable telephone was put into a trousers, a jacket, or a bag and so on.

Also, as shown in FIG. 13(3), it is configured that the depression surface of the operation key 107 is depressed by a user and a key switch gets in touch with a substrate, and thereby, an input signal is inputted to CPU 110, and a selection operation and so on which a user wishes is carried out. Here, the depression surface of the sub operation key 107 means a surface which is contacted in case that a user depresses an operation key.

Also, as described above, since there is a fear of a wrong operation when the sub operation key 107 is disposed on the back surface, it is desirable to configure in such a manner that the sub operation key 107 is configured to be able to be locked to disable the input. In this case, CPU 110 may process so as to enable or disable an input of the sub operation key 107 on the basis of a sub operation key enable signal or a sub operation key disable signal which was inputted through an exclusive use key or a setting screen and so on.

In the same manner, in the portable telephone of this embodiment, it is configured that camera shooting in the folded state can be carried out through the sub operation key 107, and it is possible to carry out camera shooting in the opened state through the main operation key 106. Therefore, to configure so as not to accept an input of the sub operation key 107 in the opened state becomes effective for improving usability. In this case, it is configured that a fold state is detected by the fold detection part 108, and in case that the opened state was detected, the input of the sub operation key 107 is not accepted. At the same time, it may be configured so as to turn OFF a display of the sub display part 104,

On one hand, it is possible to have the sub display part 104 displayed in the opened state, but in this case, it is desirable that, by reversing top and bottom of an object of shooting which was displayed in the closed state and then, by displaying it, a relationship between the top and bottom of the object of shooting on the main display part 103 and that on the sub display part 104 are made to be equal. Also in this case, a fold state is detected by the fold detection part 108 and the relationship between the top and bottom of a object of shooting which is displayed on the sub display part 104 is to differ between that in the opened state and that in the closed state.

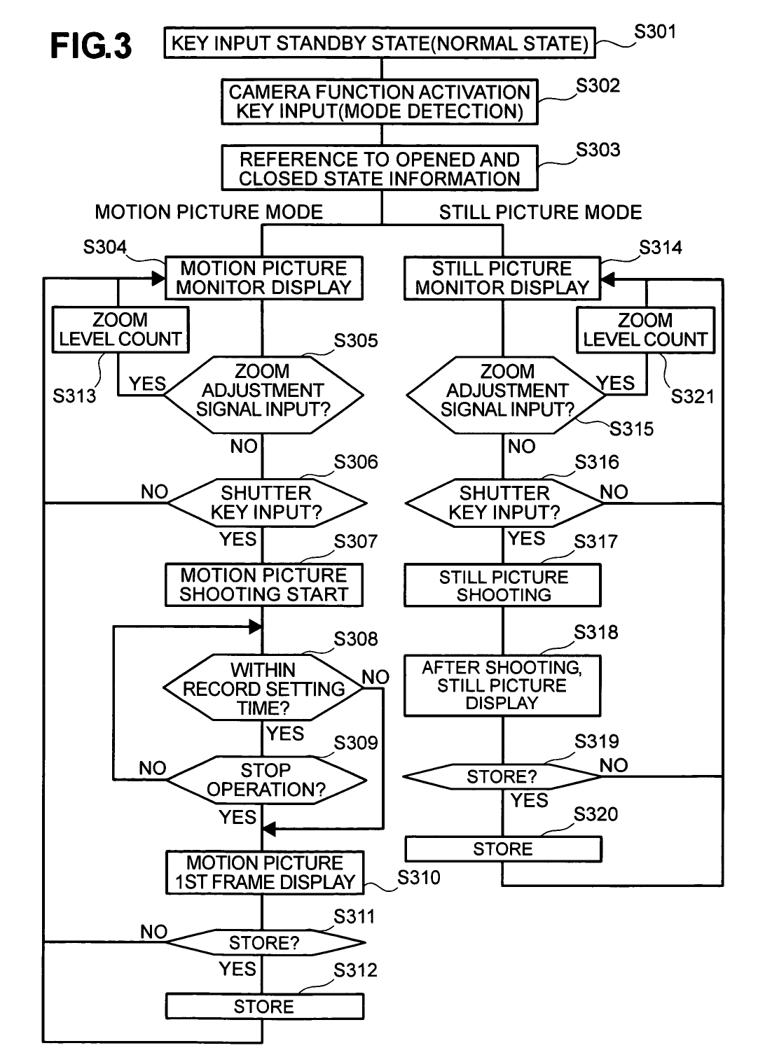

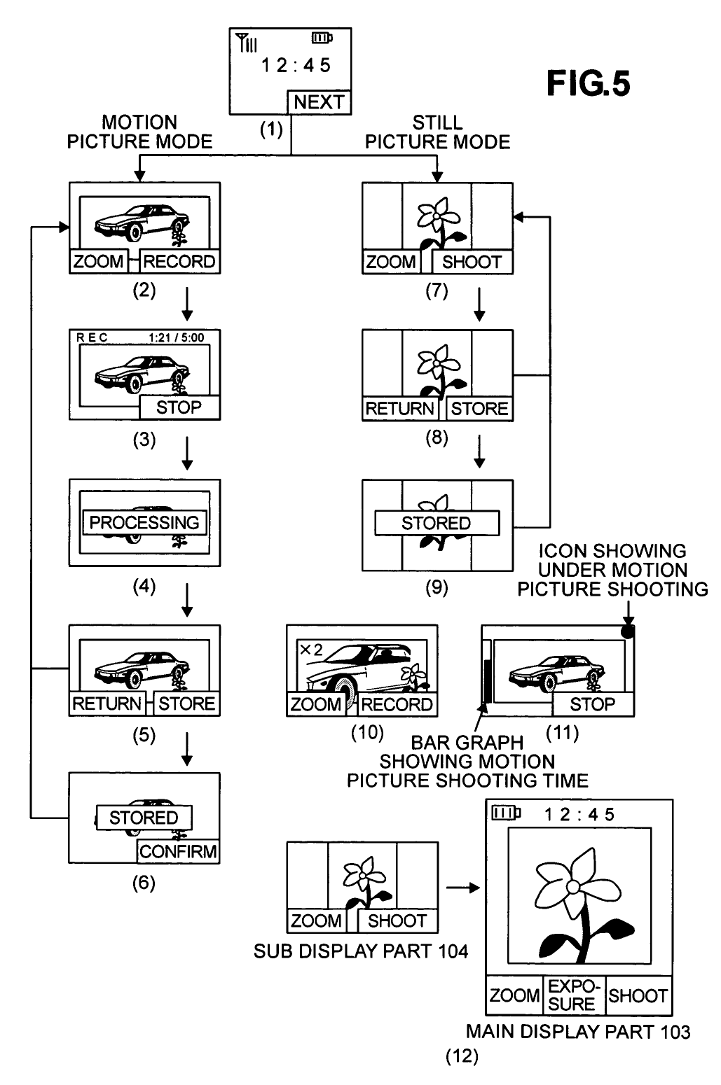

Next, camera shooting in the closed state by use of the sub operation key 107 which was described so far will be described. FIG. 3 is a flow chart thereof, and FIG. 5 is an example of a display screen which is displayed on the sub display part 104.

In addition, here, as shown in FIGS. 1(2) (4), it is assumed that there are two sub operation keys 107 (107a, 107b) on the back surface of the housing 200. For example, in a display screen as shown in FIG. 5(2), it is configured that 107a plays a role of “ZOOM” at a lower left of the screen and 107b plays a role of “RECORD” at a lower right of the screen. That is, it is configured that two functions which were displayed at the lower right side and the lower left side in the sub display part 104, two (left and right) sub operation keys 107 are made to correspond, and by depressing the right side sub operation key 107, the function which was displayed at the lower right side in the sub display part 104 is realized.

Firstly, CPU 110 stores opened and closed state information which was detected by the fold detection part 108 in the volatile memory 102a, for example, “0” in the opened state, and “1” in the closed state. And, CPU 110 refers to the opened and closed state information which was stored in the volatile memory 102a, and controls so as to have the main display part 103 displayed a predetermined display screen in case of the closed state, and controls so as to have the sub display part 104 displayed a predetermined display screen in case of the closed state.

In this embodiment, it is detected to be the closed state, and an idle screen is displayed on the sub display part 104 (S300, FIG. 5(1)).

Firstly, processing in case that the motion picture mode was selected by the mode selection key 105 will be described.

For example, when the mode selection key 105 is slid upward, a camera mode activation signal and a motion picture mode signal are inputted into CPU 110, and CPU 110 activates the camera 109 (S302) and refers to the opened and closed state information which was stored in the volatile memory 102a (S303), and information of an image which was taken by the camera 109 is displayed on the sub display part 104 through CPU 110, and a motion picture monitor is started (S304, FIG. 5(2)). On this occasion, on the sub display screen, other than a motion picture which was monitored, ZOOM and RECORD are displayed as functions which can be carried out.

In addition, here, a selection of the camera mode activation and the motion picture mode is carried out by one operation, but it is not limited to this, and there is no problem if an operation for activating the camera mode and an operation for selecting the motion picture mode are carried out separately.

Next, a user selects whether magnification of a size of information of an image which was displayed on the sub display part 104 is adjusted (zoom adjustment) or not (S305). In case of carrying out the zoom adjustment, for example, on a screen of FIG. 5(2), the sub operation key 107a to which a role of “ZOOM” was assigned is depressed, and on the basis of a sub operation key ID information signal which was inputted from the sub operation key 107a, CPU 110 changes a set value of electronic zoom magnification which was stored in a register (not shown) of the camera 109. Next, CPU 110 counts an adjustment level of the zoom adjustment (S313), and on the basis of that level, a zoomed display of the image information is carried out (S304). That is, in case that the set value of the electronic zoom magnification was changed, information of an image which was taken by that magnification is displayed on the sub display part 104 through CPU 110 (zoom adjusting method 1).

Also, at this time, CPU 110 displays a zoom adjustment level on the sub display part 104, for example, displays “x2” as shown in FIG. 5(10), and informs a user of the zoom adjustment level.

Also, in this embodiment, it is configured to carry out the zoom adjustment in incremental steps by repeating depression of the sub operation key 107a, and for example, in case of 3 steps as the steps of zoom adjustment, every time that the sub operation key 107a is depressed, CPU 110 processes in such a manner that a level returns to a normal level (level 1) next to a top level (level 3) like a level 1→a level 2→a level 3→the level 1→the level 2.

In addition, the zoom adjustment may be carried out successively by depressing the sub operation key 107a for a long time but not in incremental steps.

Next, in case that the zoom adjustment is not carried out, or in case that motion picture shooting is started after the zoom adjustment was completed, for example, in a screen of FIG. 5(2), the sub operation key 107b to which a role of “RECORD” was assigned is depressed and the motion picture shooting is started (S306).

In this case, CPU 110, on the basis of the sub operation key ID information signal which was inputted from the sub operation key 107b, compresses information of an image which was taken by the camera 109 as motion picture preparation use image data, and stores the compressed data in the volatile memory 102a, and displays the information of an image which was taken by the image pickup camera 109 on the sub display part 104 (S307, FIG. 5(3)). Also, CPU 110 activates the microphone 111, and compresses sound data which is outputted from the microphone 111 to CPU 110 as motion picture preparation use sound data, and stores the compressed data in the volatile memory 102a. On this occasion, during a period that motion picture shooting is carried out, in order to inform a user that monitor motion picture shooting is going on, CPU 110, for example, as shown in FIG. 5(3), displays a character of “REC” on the sub display part 104, and displays a transitional state of current record time to record setting time by numerical characters and so on. By this a user can recognize that the motion picture shooting is going on and how much record time remains so that usability is good.

Also, if it can be simply seen that the motion picture shooting is going on, a mode to be informed is not limited to the above-described one, and a bar graph, an icon and so on may be utilized (FIG. 5(11)). By this, it is possible to recognize viscerally that the motion picture shooting is going on and how much the record time remains.

On one hand, CPU 110, when the motion picture shooting is started, refers to the record setting time information which was stored in the volatile memory 102a, and starts a timer function which has the referred record setting time as a set value in CPU 110. In case that time which was counted by the timer function passes over the record setting time (S308), or in case that a user, for example, in a screen of FIG. 5(3), carries out an operation such depressing the sub operation key 107b to which a role of “STOP” was assigned, and so on (S309), CPU 110 stops compression of the motion picture preparation use image data and the motion picture preparation use sound data, and stops the camera 109 and the microphone 111, and combines the compressed motion picture preparation use image data and the motion picture preparation use sound data, and thereby, prepares a file of a MPEG4 format, and stores it in the volatile memory 102a. During a period of carrying out this processing, CPU 110, for example, by use of a screen as shown in FIG. 5(4), informs a user that “DURING PROCESSING” is going on, so as not to give concern of a failure and so on to a user.

Furthermore, CPU 110 refers to information of a head 1 frame from the motion picture data which was stored in the volatile memory 102a, and carries out decoding processing of the information of the head 1 frame which was referred, and displays the decoded image information (1st frame) on the sub display part 104 (S310).

And, a user refers to the image information of this 1st frame, and can select whether the motion picture information which was stored in the volatile memory 102a so far is stored in the non-volatile memory 102b or not (S311).

In case that the motion picture stored in the volatile memory 102a is stored in the non-volatile memory 102b, for example, in a screen of FIG. 5(2), when the sub operation key 107b to which a role of “STORE” was assigned is depressed, CPU 110, on the basis of the sub operation key ID information signal which was inputted, stores the file of MPEG4 format stored in the volatile memory 102a in the non-volatile memory 102b (S312). After that, when the sub operation key 107b to which a role of “CONFIRM” was assigned is depressed, CPU 110 starts again the motion picture monitoring (FIG. 5(6)).

On one hand, for example, in a screen of FIG. 5(5), when the sub operation key 107b to which a role of “RETURN” was assigned is depressed, CPU 110 displays information of an image which was taken by the image pickup camera 109 on the sub display part 104, and starts again the motion picture monitoring (S304, FIG. 5(2)).

On one hand, in case of returning to the motion picture monitor display again, without storing the motion picture stored in the volatile memory 102a in the non-volatile memory 102b, for example, in a screen of FIG. 5(5), when the sub operation key 107a to which a role of “RETURN” was assigned is depressed, a motion picture shooting data deletion signal is inputted in CPU 110, and CPU 110 deletes image data which was stored in the volatile memory 102a from a start of motion picture shooting of S307, and displays information of an image which was taken by the image pickup camera 109 on the sub display part 104, and starts again the motion picture monitoring (S304, FIG. 5(2)).

In addition, in case of finishing the motion picture shooting, it is finished by sliding the mode selection key 105 upwardly again. That is, CPU 110, on the basis of a signal from the mode selection key 105, displays an idle screen shown in FIG. 5(1) on the sub display 104.

Also, it may be configured that CPU 110, for example, displays an item of “RETURN” at a lower left of a screen of FIG. 5(3), and in case of there is no “STOP” operation within the above-described record setting time, when the sub operation key 107a to which a role of “RETURN” was assigned is depressed, CPU 110 stops compression of the motion picture preparation use image data and the motion picture preparation use sound data, and stops the microphone.

By this, in case that the motion picture shooting is mistakenly started, and in case that a user starts the motion picture shooting but changes his/her mind and wishes to stop the motion picture shooting, it is possible to quickly return to a monitoring state of the motion picture shooting. On that account, it is possible to heighten efficiency of processing of CPU 110, so that usability is improved.

Also, a method of carrying out the zoom adjustment is not limited to the above-described method, and for example, it may be configured that a set value of pickup image size of the image pickup camera 109 is changed and from information of an image which was taken by the camera 109 after the set value was changed, a size of the image size before such change is pulled out.

Next, processing in case that the still picture mode was selected by the mode selection key 105 will be described. In addition, since processes from S301 to S303 is the same as in the motion picture mode, description thereof will be omitted. However, there is a difference on a point that the mode selection key 105 is slid to a downside to which the still picture mode was assigned.

When the still picture mode is started (S314, FIG. 5(7)), a user selects whether adjustment of magnification of a size of information of an image which was displayed on the sub display part 104 (zoom adjustment) is carried out or not (S315). In addition, since an operation in case of carrying out the zoom adjustment (S315, S321) is the same as in the motion picture mode, description thereof will be omitted.

Next, in case that the zoom adjustment is not carried out, or in case that motion picture shooting is carried out after the zoom adjustment was completed, for example, in a screen of FIG. 5(7), the sub operation key 107b to which a role of “SHOOT” was assigned is depressed and the still picture shooting is carried out (S316). In this case, CPU 110, on the basis of the sub operation key ID information signal which was inputted from the sub operation key 107b, compresses information of an image which was taken by the camera 109 as motion picture preparation use image data, and stores the compressed data in the volatile memory 102a, for example, stores it as data of a format like YUV (4:2:2) in the volatile memory 102a, and stops the shooting of the camera 109 (S317) and displays the information of an image which was stored in the volatile memory 102a on the sub display part 104 (S318, FIG. 5(8)).

After that, a user selects whether the still picture which was stored in the volatile memory 102a is stored in the non-volatile memory 102b or not (S319, FIG. 5(8)).

In case that the still picture which was stored in the volatile memory 102a is stored in the non-volatile memory 102b, in such a state that the information of an image which was shot is displayed on the sub display part 104, for example, in a screen of FIG. 5(8), the sub operation key 107b to which a role of “STORE” was assigned is depressed (S319). By this, on the basis of the sub operation key ID information signal which was inputted from the sub operation key 107b, CPU 110 compresses the data of YUV (4:2:2) format which was stored in the volatile memory 102a by for example, JPEG format, and stores it in the non-volatile memory 102b (S320, FIG. 5(9)).

Also, in case of returning to the still picture monitor display (FIG. 5(7)) in such a state that information of an image which was shot was displayed on the sub display part 104 (FIG. 5(8)), for example, in a screen of FIG. 5(8), when the sub operation key 107a to which a role of “RETURN” was assigned is depressed (S316), CPU 110 starts again the shooting of the image pickup camera 109, and displays the information of an image which was taken by the image pickup camera 109 through CPU 110 on the sub display part 104, and starts again the still picture monitoring (S314).

Also, in case of finishing the motion picture shooting, it is finished by sliding the mode selection key 105 downwardly again. That is, CPU 110, on the basis of a signal from the mode selection key 105, displays an idle screen shown in FIG. 5(1) on the sub display part 104.

By the foregoing, without taking the trouble to open a portable telephone, the motion picture mode or the still picture mode is made to be activated, and by utilizing the sub operation key 107a and 107b which were disposed on the back surface, it is possible to carry out the shooting so that usability is improved.

Also, since a user displays the information of an image which was taken by the image pickup camera 109 on the sub display part 104, before storing the image information in the non-volatile memory 102b, and after that, can select whether it is stored in the non-volatile memory 102b or not, it is possible to store only an image which a user really wish to store in the non-volatile memory 102b so that usability is good.

Furthermore, since there is no necessity to store information of an image which was failed to be taken and information of an image which was mistakenly taken in the non-volatile memory 102b, it is possible to effectively make use of limited memory capacity.

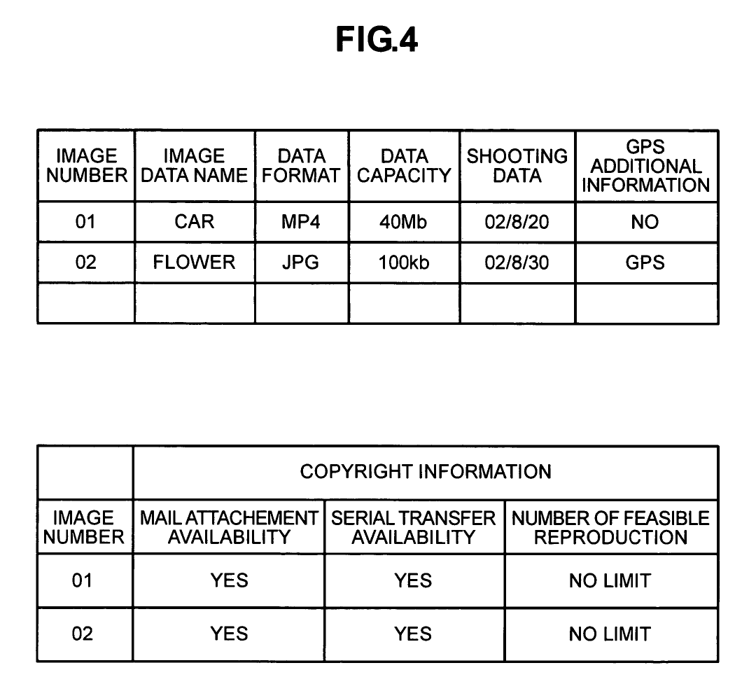

In addition, image information of a motion picture or a still picture which was taken, for example, is stored in the memory 102 by use of a format as shown in FIG. 4 (S312, S320). It is recorded in association with each item such as, for example, as a storage format, “image number” which represents a number of information of an image which was taken, “image data name” which represents a name of image data, “data format” which represents a data format such as JPEG, MPEG and so on, “amount of data” which represents capacity of data, “image pickup date” which represents a date of image pickup, “GPS additional information” which represent additional information such as GPS and so on, “good and bad of attachment to a mail of copyright information” which represents whether it is good or not to attach data of an image which was taken to a mail, “good and bad of serial transfer of copyright information” which represents whether it is good or not to serially transfer data of an image which was taken to other information processing terminal, for example, PC, PDA, a portable telephone and so on, “the number of possible reproductions of copyright information (or time of possible reproductions)” which represents the number (or time) of reproduction of data of an image which was taken, and so on. If it is stored in the suchlike manner, it is suitable on the occasion of utilizing data of an image which was taken.

In the meantime, the above-described sub operation key 107 is controlled by CPU 110, and even if the same key was depressed, in a different state, it may be treated as a different input signal.

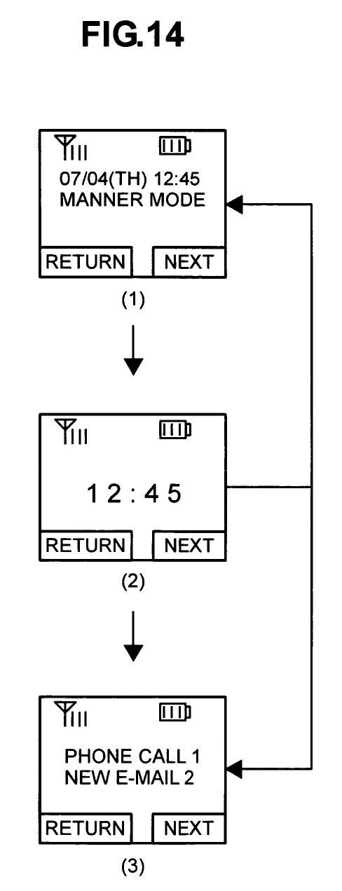

For example, the sub operation key 107 is, in case of a normal standby state, for example as shown in FIG. 14, used for switching a screen of the sub display part 104. Hereinafter, it will be described by use of FIG. 14.

FIG. 14(1) is an example of a screen in which set information of a mode such as “MANNER MODE” and so on was displayed, and FIG. 14(2) is an example of a screen in which current time information was displayed in an enlarged manner, and FIG. 14(3) is an example of a screen in which newly arrived information of a telephone, a mail and so on was displayed.

In each screen of FIG. 14(1) to FIG. 14(3), the sub operation key 107a functions as a “RETURN” key, and the sub operation key 107b functions as a “NEXT” key.

When the “NEXT” key 107b is depressed, a screen transition signal is inputted to CPU 110 as an input signal, and CPU 110 which received the screen transition signal switches a display screen of the sub display part 104 to a next screen. By repeating this operation, a screen is switched in such manner of FIG. 14(1)→FIG. 14(2)→FIG. 14(3)→FIG. 14(1)→ . . . .

On one hand, when the “RETURN” key 107a is depressed, a screen return signal is inputted to CPU 110 as an input signal, and CPU 110 which received the screen return signal switches a display screen of the sub display part 104 to a previous screen. By repeating this operation, a screen is switched in such manner of FIG. 14(1)→FIG. 14(3)→FIG. 14(2)→FIG. 14(1)→ . . . .

In contrast to this, in case of the camera mode in which shooting is carried out by the image pickup camera 109, the sub operation key 107a is assigned by CPU 110 as an operation key regarding camera shooting, for example, the shutter key, and when the sub operation key 107a is depressed, a shutter signal is inputted into CPU 110 as an input signal.

In addition, in FIG. 14(3), in case that there is no newly arrived information, it may be configured that the number is displayed as “0”, and a screen itself of FIG. 14(3) is not displayed. In this case, it is controlled by CPU 110 in such a manner that when the “NEXT” key 107b is depressed in FIG. 14(2), it is changed to FIG. 14(1) and when the “RETURN key 107a is depressed in FIG. 14(1), it is changed to FIG. 14(2)”.

By this, by such an arrangement that the screen itself regarding newly arrived information is not displayed in case of no newly arrived information, a user can confirm presence and absence of newly arrived information sensuously by a transition state of a screen, so that usability is good.

As above, since the sub operation key 107 changes a role of an input signal as the case may be and one operation key can play a plurality of roles, in a small size terminal like a portable telephone, it is possible to effectively make use of a space, which contributes to reduction of circuit size.

Furthermore, for example, in case of playing a game by making use of the sub display part 104, and in case of displaying information regarding music such as a music file etc. of mp3 etc. in the sub display part 104, it is possible to make use of it as an operation key for them.

In addition, in the above-described embodiment, the case of completing camera shooting in the closed state was described, but next, a structure which enables camera shooting successively even if it goes into such a state that a portable telephone was opened in midstream of its operation will be described.

In this case, CPU 110, if it confirms that it goes into the opened state with reference to the opened and closed state information which was detected by the fold detection part 108, holds once a state of a camera operation which was carried out by the sub operation key 107 so far (a display screen in use, a zoom adjustment level and so on), and displays a display screen which was in advance associated with the display screed which was held on the main display part 103 (e.g., FIG. 5(12)).

Here, in the non-volatile memory 102b, a display screen in each step which is displayed on the sub display part 104 (e.g., FIG. 5(1) to FIG. 5(9)) and a display screen in each step which is outputted to the main display part 103 are stored in association with each other. In addition, although it is not shown in the figures, it is configured that CPU 110 outputs a screen which corresponds to FIG. 5(1) to FIG. 5(9) as a display screen which is displayed on the main display part 103 in the opened state. In this case, it is desirable that the number of display screens which are displayed on the sub display part 104 is made to be equal to the number of display screens which are displayed on the main display part 103.

FIG. 5(12) is FIG. 5(7) and an example of a display screen which was associated with it, and in a state that a portable telephone was opened, it is possible to make use of the main operation key 106. On that account, other than “ZOOM” “SHOOT”, adjustment of “EXPOSURE” is assigned to the operation key, and also, taking size of an area of the main display part into consideration, it was designed that a remaining amount of a rechargeable battery, time and so on are also displayed. Also, taking a difference of a screen size between the sub display part 104 and the main display part 103 into consideration, information of an image which was taken by the camera is processed so as to be displayed with a size which is coordinated with the screen size.

By this, even if the closed state was changed to the opened state during a period that the camera shooting function is activated, it is possible to carry on the camera shooting through a display screen which is suited to respective states, so that usability is improved. It is the same as in a case that the opened state was changed to the closed state.

In addition, the associated display screen is not limited to a display screen as shown in FIG. 5(12), but for example, it may be configured that display screens which are displayed on the sub display part 104 and the main display part 103 become a similar screen, key assignment. If it is configured so, there is such an advantage that even if the opened state is transferred to the closed state, a camera operation can be carried on by a similar operation.

Also, here, in order to easily carry out a search of the associated display screens, search information is added to each display screen data, such as for example, in a screen as shown in FIG. 5(7), “sub07” and in a display screen which is displayed on the main display part which corresponded to that, “main07”. On the basis of this search information, CPU 110 searches a screen to be outputted, and outputs it to respective display parts. By this, it is possible to heighten search efficiency of the associated display screens. In this case, by making use of the search information, a display mode to be displayed on the sub display part 104 and a display mode to be displayed on the main display part 103 are stored in the non-volatile memory 102b in such a manner that the modes are associated with each other.

As above, switching from main to sub in camera shooting was described, but it is not limited to the camera shooting, and it is applicable to one which outputs an image to a predetermined display screen.

In the meantime, as shown in FIGS. 1(2) and 1(4) etc., the reason that the number of sub operation keys to which the shooting time operation key was assigned is set to be 2 is because an area of the back surface of the housing 200 is limited, and it the number becomes 3 and more, a distance between keys becomes narrower, so that there is a fear to invite such a wrong operation that an adjacent key is mistakenly depressed and so on.

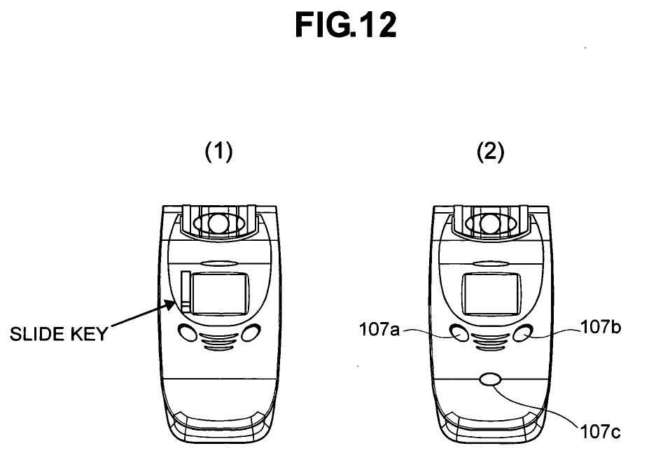

Therefore, for example, if it is configured so as to prevent a fear of a wrong operation by changing a shape of a key such that one is a slide type key (FIG. 12(1), and by making a distance between keys larger (FIG. 12(2)), it may be configured that for example, 3 keys and more of the shooting time operation key such as the shutter key, the zoom adjustment key and so on are disposed on the back surface of the housing 200.

Also, here, as shown in FIG. 12(2), in case of a 3 key structure on the back surface, it is possible to make use of a circuit regarding main operation keys 106a, 106b and 106c for sub operation keys 107a, 107b and 107c on the back surface without any change, which contributes to reduction of manufacturing cost.

Also, in case that the sub operation key 107 is 2 keys, since there is a fear that when two sub operation keys 107a and 107b to be disposed are disposed to be two keys up and down, the up operation key was pressed by a thumb and the down operation key is depressed, so that usability is bad, as shown in FIGS. 1(2) and 1(4) etc., they may be disposed left and right, and for example as shown in FIG. 12(2), it is more preferable to have disposed them with sifted in an oblique direction.

Also, it is preferable to configure that for example, functions of the sub operation keys 107a and 107b at the time of camera operation are made to be the same as that of the main operation keys 106a and 106b, and an operation in the opened state is made to be the same as an operation in the closed state. That is, it is preferable to configure so as to be able to realize similar ones to processing operations which were shown in FIGS. 3 and 5 by use of the main operation keys 106a and 106b in the opened state. By this, a necessity to take the trouble to change operations between in the opened state and in the closed state is eliminated so that usability of a user is improved.

Furthermore, in this embodiment, a sound hole is disposed between the sub operation key 107a and 107b, and by this, a user can easily identify a position of the sound hole by tactile sensation, and on the basis of that, a physical relationship of both keys becomes clear, and therefore, without taking the trouble to identify a position of the key, it is possible to operate it sensuously. Also, by this a distance between the sub operation keys 107a and 107b is taken, so that it is possible to prevent a wrong operation such as a wrong depression and so on.

In addition, here, the sound hole of a music speaker was disposed between the sub operation keys 107a and 107b. However, it is not limited to this, but if it is possible to clarify a physical relationship of the both keys, a convex prong or a concave groove and so on may be disposed. In the meantime, in this embodiment, the mode selection key 105 which is used also as the activation key was formed on the side surface of the housing 201 by use of a slide type key, but since a certain degree of power is required in order to have the operation key slid for mode selection, it is configured so as to prevent a wrong operation of a user. In particular, usability is good on a point that even if the mode selection key 105 was depressed when the housing was held, it is not operated.

Also, assuming that the mode selection key 105 is disposed on the side surface of the housing 200 and when sliding it upward in the closed state, a mode is transferred to the motion picture mode and when sliding it downward, it is transferred to the still picture mode, when sliding it upward in a state that a portable telephone was opened, although it was transferred to the motion picture mode in the closed state, here, it is transferred to the still picture mode.

Therefore, as shown in FIG. 1, when a slide type key is used as the mode selection key 105 and it is disposed on the side surface of the housing 201, regardless of the opened and closed states of a portable telephone, the same mode selection can be realized by the same slide operation so that usability is good.

Next, processing of the main display part 103 and the sub display part 104 at the time of camera shooting will be described.

Firstly, in a state that a portable telephone was opened, it will be described. In case that a lens of the image pickup camera 109 was directed toward a user, unless a pickup image of a user himself/herself at this time is displayed on the main display part 103 by a mirror image, for example, in case that a user moved to right, on the screen, it is displayed that a user moved to left, and there is a problem that it is hard to shoot. On that account, CPU 110 detects that a portable telephone is in the opened state by use of the fold detection part 108, and detects that the image pickup camera 109 faces toward a user by use of for example, a sensor, a switch and so on, and carries out flip horizontal of an image.

Next, in case that a lens of the image pickup camera 109 is directed toward an object of shooting which was opposed to a user in a state that a portable telephone was opened, at this time, the image pickup camera 109 is approximately 180 degree folded around an X-X axis of FIG. 1(1), an image which is displayed on the main display part 103 becomes upside down. In this connection, CPU 110 detects that a portable telephone is in the opened state by use of the fold detection part 108, and detects that the image pickup camera 109 faces toward a user by use of for example, a sensor, a switch and so on, and carries out flip vertical of an image. Also, in this case, it is also possible to display an image which was taken in by the image pickup camera 109 on the sub display part 104, and on this occasion, CPU 110 detects that a portable telephone is in the opened state by use of the fold detection part 108, and detects that the image pickup camera 109 faces toward a user by use of for example, a sensor, a switch and so on, and carries out flip horizontal of an image, and displays it on the sub display part 104.

Next, a state that a portable telephone was closed will be described. In case that a lens of the image pickup camera 109 is directed toward a user in the state that a portable telephone was closed, at this time, as described above, since an image which is displayed on the sub display part 104 should be a mirror image, CPU 110 detects that a portable telephone is in the closed state by use of the fold detection part 108, and detects that the image pickup camera 109 faces toward a user by use of for example, a sensor, a switch and so on, and carries out flip horizontal of an image.

Next, in case that a lens of the image pickup camera 109 is directed toward an object of shooting which is opposite to a user in the state that a portable telephone was closed, as described above, since an image is displayed upside down on the sub display part 104, CPU 110 detects that a portable telephone is in the opened state by use of the fold detection part 108, and detects that the image pickup camera 109 faces toward a user by use of for example, a sensor, a switch and so on, and carries out flip vertical of an image.

As above, by detecting opened and closed states of a portable telephone and a direction of the camera at that time, and by having a display mode of the main display part 103 or the sub display part 104 flipped horizontally or flipped vertically, usability at the time of shooting is improved.

Also, in case that the camera is directed toward an object of shooting in the opened state, by displaying an image pickup monitor screen not only on the main display part 103 but also on the sub display part 104, a person who is shot (object of shooting) can also confirm a state of shooting himself/herself, and therefore, it is possible to be shot at ease.

Still also, it may be configured that after shooting, without any change of the state that a portable telephone was closed, by use of the sub display part 104, confirmation or deletion and so on of an image which was taken is carried out.

In this case, for example, when a mode is changed to a browsing mode for confirming images which were taken by the mode selection key 105, CPU 110 displays the images which were taken on the sub display part 104. As a display mode, it is fine if the images which were taken can be confirmed, and for example, the images which were taken may be displayed one by one in an chronological record order, or may be displayed as a list. On that occasion, if a user selects an image which he/she wants to delete by use of the sub operation key 107 and instructs deletion, an image deletion instruction signal is inputted through the sub operation key 107 to CPU 110, and CPU 110 carries out processing to delete image data which was stored in the memory 102.

Also, it may be designed to carry out editing and so on of images which were taken, by use of the sub display part 104. In this case, when a mode is changed to an editing mode by depressing the mode selection key 105, CPU 110 displays a screen for selecting an editing function such as for example, black and white, sepia, frame and so on, on the sub display part 104. When a user selects any one of the editing functions by the sub operation key 107, the editing instruction signal is inputted to CPU 110, and CPU 110 edits image data on the basis of the editing instruction signal.

By this, without taking the trouble to open a portable telephone after shooting, without any change of the state that a portable telephone was folded, the limited number of sub operation keys are used and thereby, it is possible to carry out confirmation, editing and so on of images which were taken so that usability is improved.

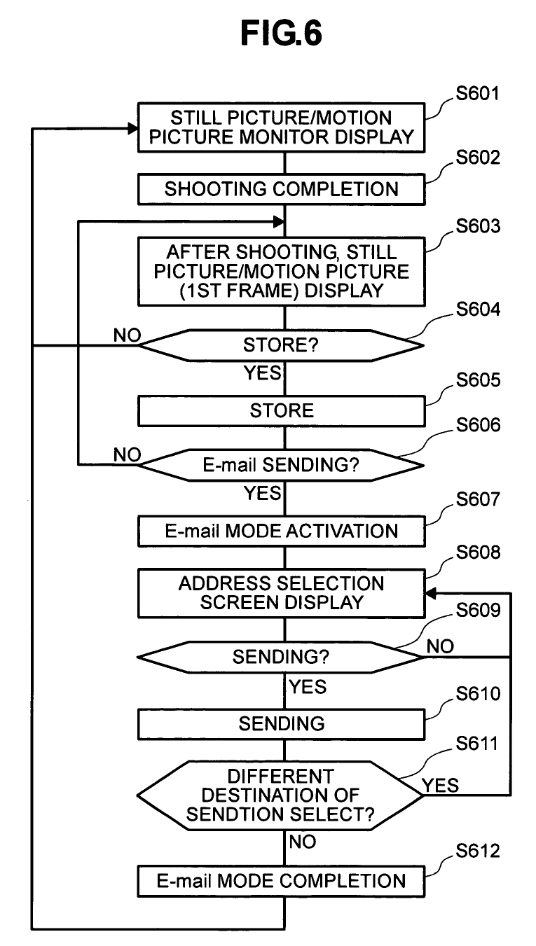

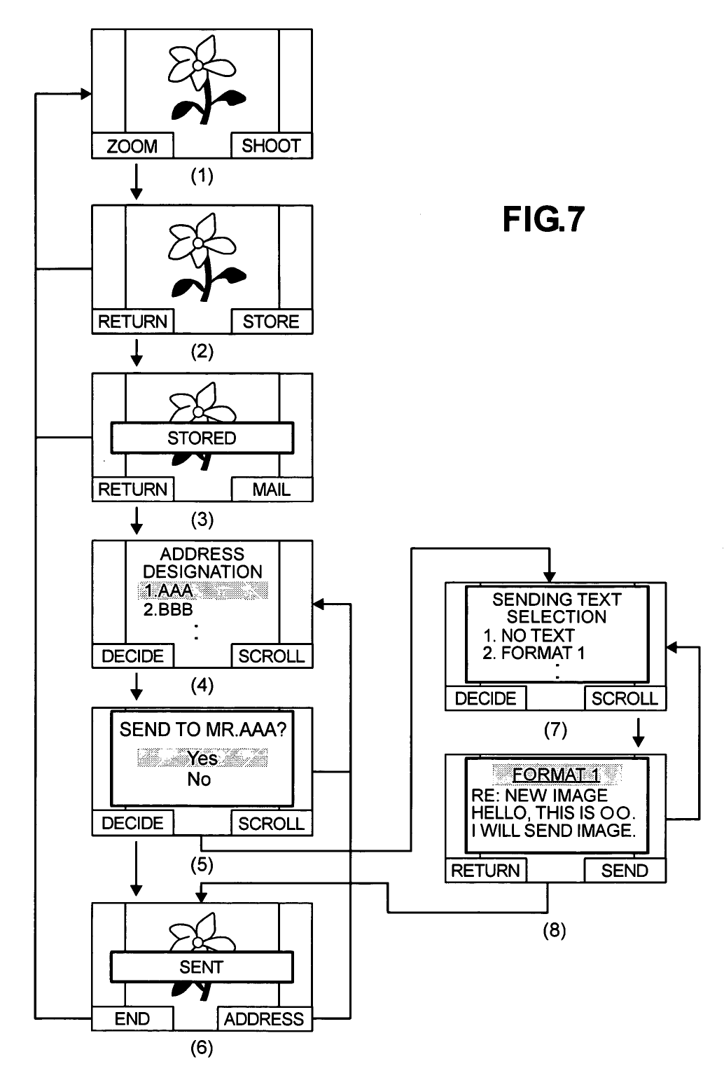

Next, processing in case of sending a mail with a still picture or a motion picture which was taken as an attachment file, after the still picture or the motion picture was taken by making use of the above-described sub operation key 107, in a state that a portable telephone was closed will be described (second embodiment). Hereinafter, it will be described by use of a flow chart of FIG. 6 and a display screen example of FIG. 7.

In addition, since processes from S601 to S605 of FIG. 6 are ones which are formed by simplifying processes from S304 to S312 and from S314 to S320 of FIG. 3, and FIGS. 7(1) and 7(2) are the same as FIGS. 5(7) and 5(8), descriptions thereof will be omitted here.

Now, in FIG. 7(3), the sub operation key 107a functions as a “RETURN” key and the sub operation key 107b functions as a “MAIL” key.

When a signal from this “RETURN” key 107a is inputted to CPU 110 (S606), CPU 110 deletes a display which was displayed on the sub display part 104, and displays a still picture or a motion picture (1st frame) as shown in FIG. 7(2), newly on the sub display part 104.

On one hand, in FIG. 7(3), when a signal from a mail key 107b is inputted to CPU 110 (S606), CPU 110 activates E-mail mode (S607), and secures a region for use in mail editing in the non-volatile memory 102b, and designates still picture data or motion picture data which was stored in the non-volatile memory 102b as a file which is attached to a mail to be sent. Subsequently, CPU 110 refers to address book data which was stored in the non-volatile memory 102b, and for example, as shown in FIG. 7(4), displays name information of friends, acquaintances and so on (“AAA”, “BBB” . . . ) on the sub display part 104 (S608). Here, the name information, if it represents friends, acquaintances and so on, may not be real names but maybe nick names, cryptographs or numerical characters and so on.

In FIG. 7(4), the sub operation key 107a functions as a “DECIDE” key, and the sub operation key 107b functions as a “SCROLL” key.

When a signal from the scroll key 107b is inputted to CPU 110, CPU 110 scrolls a cursor and so on for selecting a person to which a mail is sent from a list of name information which is displayed on the sub display part 104.

Also, when a signal from the decide key 107a is inputted to CPU 110, CPU 110, in order to confirm a user whether a person who was selected by the cursor and so on is set to be a destination to which a mail is sent or not, displays a display for having a user select availability of sending, for example, as shown in FIG. 7(5), on the sub display part 104 (S609).

Also in FIG. 7(5), in the same manner as in FIG. 7(4), the sub operation key 107a functions as a “DECIDE” key, and the sub operation key 107b functions as a “SCROLL” key.

In a state that a cursor was moved to a position of “NO” by the scroll key 107b, when a signal from the decide key 107a is inputted to CPU 110, CPU 110 displays a screen for selecting a person to which a mail is sent in FIG. 7(4) on the sub display part 104. On this occasion, if it is configured to put the cursor to a position of the name information of the destination designated last time to which a mail is sent, a necessity to take the trouble to search again the name information list from its head is eliminated so that usability is improved.

On one hand, in a state that the cursor was moved to a position of “Yes” by the scroll key 107b, when a signal from the decide key 107a is inputted to CPU 110, CPU 110, searches the address book data which was stored in the non-volatile memory 102b by use of a name of a person who was selected in S608 as a search key, and refers to a mail address which corresponds to the search key, and copies it in a mail address region for use in editing mails which was secured in the non-volatile memory 102b.

After that, CPU 110, for example, establishes a link to a communication network such as a portable telephone network and so on, and then, connects to a mail server (not shown). Subsequently, CPU 110 outputs data of the region for use in editing mails which is in the non-volatile memory 102b to a communication part 101, and the communication part 101 sends mail data to the mail server through a wireless link which was established previously (S610).

When sending of the mail data is completed, CPU 110 finishes a connection with the mail server and finishes communication by opening the established wireless link, and for example, as shown in FIG. 7(6), displays a display for informing a user that the sending of the mail was completed on the sub display part 104.

In FIG. 7(6), the sub operation key 107a functions as a “END” key, and the sub operation key 107b functions as an “ADDRESS” key, and a user selects whether or not sending of a mail is carried out to a person who is different from the person designated previously to whom a mail is sent, or whether or not the E-mail mode is finished (S611).

When the address key 107b is depressed and a signal from the address key 107b is inputted to CPU 110, CPU 110 displays a screen for selecting a person to which a mail is sent of FIG. 7(4) on the sub display part 104 (S608), and carries out processes from the above-descried S609 to S611.

On one hand, when the end key 107b is depressed and a signal from the end key 107b is inputted to CPU 110, CPU 110 has activation of the E-mail mode finished (S612), and carries out a display of a still picture or a motion picture monitor which was taken in by the image pickup camera 109 (S601) (FIG. 7(1)).

As above, since it is configured that a mode is automatically transferred to the E-mail mode, after a still picture or a motion picture was shot in the state that a portable telephone was closed, without taking the trouble to open a portable telephone, it is possible to send a still picture of a motion picture which was taken to a person who one wants, so that usability is improved.

Also, since it was configured that, in the state that a portable telephone was closed, without inputting characters, numeric characters and so on, only by an operation for selecting a person to which a mail is sent, information of an image which was taken is sent with being attached to a mail, even in case of the limited number of operation keys (sub operation key 107) on the back surface, it is possible to quickly send a mail by a simple operation.

Also, normally, in the state that a portable telephone was opened, since it is possible to make use of the main display part 103 which has a relatively large area and the main operation key 106 which has a plenty of operation keys, outputted is a display screen for inputting a destination to be sent, a subject matter, and a text (characters, pictographic characters, numeric characters and so on). Therefore, in this embodiment, it is configured that, in the opened state, image information is sent to the main display part 103 by an E-mail function which used a display screen in which character inputting is available, and it is configured that, in the closed state, image information is sent to the sub display part 104 by use of a display screen having no character input. In addition, even in the opened state, as shown in FIG. 7, it is also possible to send a mail with transition of a display screen which prohibits the character input, and in this case, for example, if it is configured that a user can select a mode by dividing a mode into for example, a “NORMAL MODE” in which character inputting is available, and a “SIMPLIFIED MODE” in which character inputting is prohibited, usability is better.

Also, in the above-described embodiments, taking operability and swiftness in the closed state into consideration, described was an example of sending only image information without inputting text information such as characters, numeric characters and so on, but depending on the circumstances, there may be a state that one wants to send any text together with image information. In this case, it is realized by such actions that a user prepares a given text (title, content of a text and so on), and has the text registered in advance.

And, it is realized by configuring that, after a destination to which a mail is sent was determined in S609, CPU 110 copies a text format (title, content of a text and so on) which was stored in the non-volatile memory 102b in advance to the region for use in editing mails which was secured in the non-volatile memory 102b to thereby complete the mail editing and it is sent to the selected sending destination (S610). That is, it is realized by configuring that a text which was registered in advance is sent to the selected sending destination.

By this, even in case of the closed state, it is possible to send a text of a format which was registered in advance only by an operation for designating an address of a sending destination, and it becomes possible to send any text to a sending destination.

Also, it may be configured to have a user selected whether a text format is sent or not or a text format which is sent out of a plurality of text formats.

In this case, CPU 110, for example, after a screen of FIG. 7(5) was outputted, outputs a screen like FIG. 7(7), and a user selects a format of a text to be sent. Here, in case that “NO TEXT” was selected, CPU 110 does not copy any texts to the region for use in editing mails, and processes so as to send only image information. Also, for example, as shown in FIG. 7(8), in case that the text format “FORMAT 1” was selected, CPU 110 displays a content of the selected text format (format 1).

Next, when an input signal from the sub operation key 107a which functions as the “RETURN” key in FIG. 7(8) is inputted, CPU 110 processes so as to return to a screen of FIG. 7(7). On one hand, when an input signal from the sub operation key 107b which functions as a “SEND” key in FIG. 7(8) is inputted, the selected text format is copied to the region for use in editing mails which was secured in the non-volatile memory 102b to have the mail editing completed, and sent to the selected sending destination (S610, FIG. 7(6)).

By this, a user can select a text format in response to a person to which a mail is sent and information of an image which was taken, so that usability is good.

Also, since it was configured that a content of a text is displayed prior to mail sending, a user can confirm a content of a text to be actually sent in advance, and for example, it is possible to prevent such a wrong operation that a text format with a content which is different from that of a text format that one wants is selected. Also, if tiles are included, it may be configured to have a list of the titles displayed.

In addition, here, if it is configured that a user can register a plurality of text formats in the non-volatile memory 102 in advance, it is needless to say that usability is good.

Also, in the above-described embodiment, described was the case that information of an image which was taken by the image pickup camera 109 is simply attached to a mail without any change of the closed state and the mail is sent together with the image information, but it is not limited to this, and a mail which does not have image information attached hereto may be sent.

In this case, for example, in a standby state as shown in FIG. 5(1), it may be configured that activation processing of the E-mail mode can be carried out, and it may be configured that, in processing after this, processing from the above-described S607 to S612 (FIGS. 7(4) to 7(6)) is carried out.

By this, for example, even in case that an electric train which I get on board is involved in the accident and there is a necessity to quickly contact to a company and home, and so on, since it is possible to get in touch with a superior of a company, family and so on by sending a mail having such a predetermined content, for example, that “Please understand that I will be delayed because of an emergency situation. I will be in tough with you again when it goes into a state that I can contact later.” In the state that a portable telephone was closed, and by a simple operation, so that usability is good.

On one hand, in the embodiments which were described so far, described was the example that mail sending is completed in the closed state, but it is assumed that a portable telephone goes into the opened stated in the midstream of its operation.

In this connection, an example for alerting to return to the closed state again, in case that a portable telephone went into the opened state in the midstream of operation for sending a mail in the closed state, will be described.

In this case, CPU 110, if confirms that it went into the opened state with reference to the opened and closed state information which was detected by the fold detection part 108 during a period of a mail operation, holds once the operations which were carried out by the sub operation key 107 so far, and displays on the main display part 103 an alert message of for example, “A mail is being prepared. Please close a portable telephone.”, and so on. After that, CPU 110, if recognizes that it went into the closed state with reference to the opened and closed state information which was detected by the hold detection part 108, displays the display screen which was displayed on the sub display part 104 right before a portable telephone is opened, on the sub display part 104 again, and processes so as to continuously carry out the operation.

By this, for example, in case that a use opened a portable telephone unintentionally in the midstream of an operation for sending a mail in the closed state, and so on, since the alert message is displayed on the main display part 103, it is possible to urge a user to close a portable telephone and to continuously carry out the operation of mail sending.

In addition, as alert means, for example, to display a color for alerting (e.g., red color) on the main display part 103 or the sub display part 104, or to give alert by use of alert sounds, or to give alert by use of combination of the alert sound, character and color information may be carried out. Or, it may be configured to have a user selected a type of the alert sound and characters to be displayed.

Also, in the above-described embodiment, since there was such assumption that an operation of mail sending can not be carried out by the main operation key 10 in case that it went into the opened state in midstream, carried out was alert for returning to the closed state, but if, even in the opened state, the operation of mail sending can be carried out continuously by use of the main operation key 107, usability is good.

In this case, CPU 110, if confirms that it went into the opened state with reference to the opened and closed state information which was detected by the fold detection part 108, holds once the operations which were carried out by the sub operation key 107 so far, and displays on the main display part 103 the display screen which was displayed right before a portable telephone is opened. In this case, CPU 110 processes in such a manner that assignment of functions to the operation key which are displayed at left and right downsides of a display screen of the main display part 103 becomes the same as that of the sub display part 104. That is, processing is carried out in such a manner that a display shown in FIG. 7 and so on is switched from the sub display part 104 to the main display part 103, and in each display screen, ones which were assigned to the sub operation keys 107a and 107b are assigned to the main operation keys 106a and 106b. Also, in case that a portable telephone was closed again, similar processing to the above-described processing is carried out.

By this, a common display screen is utilized in both of the closed state and the opened state, and roles of the operation keys which were disposed on the front surface and roles of the operation keys which were disposed on the back surface, for example, a role of the main operation key 106a and a role of the sub operation key 107a, a role of the main operation key 106b and a role of the sub operation key 107b, are made to be the same, and thereby, even if a portable telephone went into the opened state in the midstream of an operation for sending a mail in the closed state, it is possible to continuously carry out the mail sending by a similar operation so that usability is good.

Next, an embodiment in which a text can be inputted by the main display part 103 which is of a relatively large size and the main operation key 106 which includes a plenty of operation keys, by opening a portable telephone after a person to whom a mail is sent was selected in the closed state will be described.

In this case, for example, in case that a portable telephone was opened after a sending destination was selected on a screen as shown in FIG. 7(4), CPU 110 recognizes that it went into the opened state with reference to opened and closed state information which was detected by the fold detection part 108, and displays on the main display part 103 an input screen wherein characters, numerical characters and so on can be inputted. And, it is configured that a user, by making use of the main operation key 106, inputs characters and so on in this input screen, and can carry out sending of a mail.

By this, for example, in case that a user was thinking that he/she will send an email quickly without any change of the closed state once, but changed his/her mind in midstream and thought that he/she wanted to input also a text and send it, since the input screen for characters and so on are automatically displayed on the main display part 103, only by opening a portable telephone, usability is good. In this case, “after a destination of mail sending was selected” was set as a condition, but it may be configured to carry out similar processing even before a sending destination is selected. In this case, it may be configured simply to automatically activate a normal mail function which is used in the opened state.

As above, the mail sending function in the closed state was described, but it is needless to say that a key layout, a display screen and so on are not limited to this embodiment. Also, as to a structure of sending by a display screen with not character input, it is needless to say that it is applicable not only to a fold type portable telephone but also other portable telephone.

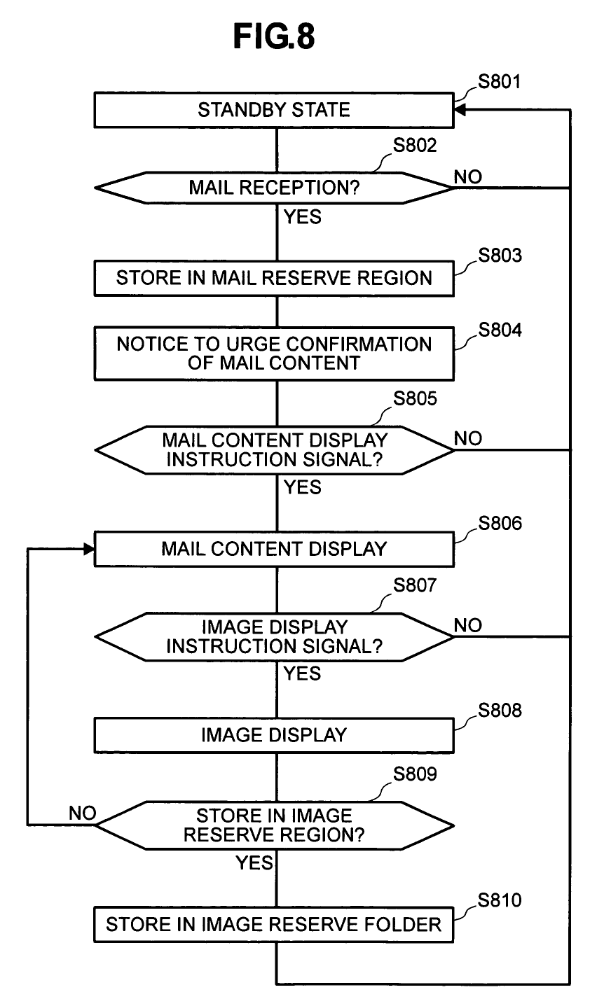

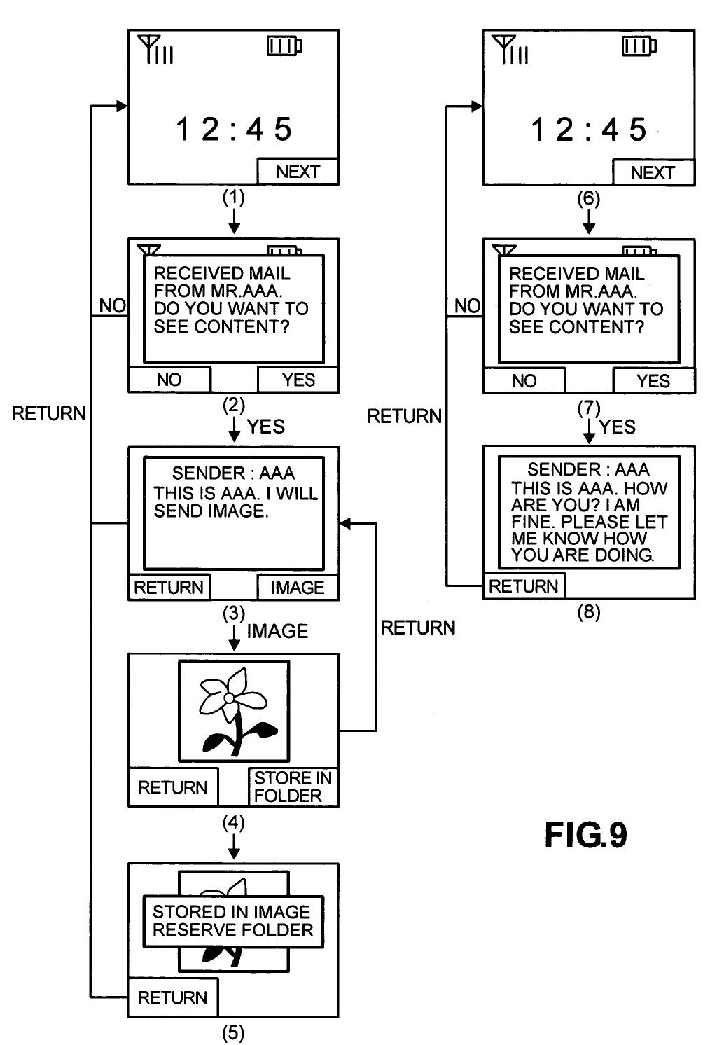

Next, processing in case that a mail was received in a state that a portable telephone was closed will be described (third embodiment). Hereinafter, it will be described by use of a flow chart of FIG. 8 and a display screen example of FIG. 9.

For example, in the standby state in which an idle screen as shown in FIG. 9(1) is displayed (S801), when a mail is received from a mail server through a communication network such as a portable telephone network and the communication part 101, CPU 110 which received a mail reception signal sends a mail data download request signal to the mail server, and further, the mail server which received the download request signal sends mail data to a portable telephone (S802). At this time, CPU 110 which received mail data stores the mail data in a mail reserve region of the non-volatile memory 102b.

Further, at this time, CPU 110 refers to a mail address of a sender from the mail data which is in the non-volatile memory 102b, and refers to a corresponding name by searching address book data which are in the non-volatile memory 102b by use of the referred mail address as a search key, and for example, as shown in FIG. 9(2), displays a display for inquiring whether a name of the sender and a content of the received mail are confirmed or not on the sub display part 104 (S804).

In FIG. 9(2), the sub operation key 107a functions as a “No” key, and the sub operation key 107b functions as a “Yes” key.

When a signal from this No key 107a is inputted to CPU 110, CPU 110 displays, for example, an idle screen as shown in FIG. 9(1) on the sub display part 104 (S805). At this time, for the purpose of informing a user that there is mail data which content is not confirmed, CPU 110 may display an appropriate icon on the sub display part 104.

On one hand, when a signal from the Yes key 107b is inputted to CPU 110 (S805), CPU 110 refers to the mail data which is in the non-volatile memory 102b, and displays, for example as shown in FIG. 9(3), on the sub display part 104 (S806).

In FIG. 9(3), the sub operation key 107a functions as a “RETURN” key and the sub operation key 107b functions as an “IMAGE” key.

When a signal from this “RETURN” key 107a is inputted to CPU 110, CPU 110 displays, for example, an idle screen as shown in FIG. 9(1) on the sub display part 104 (S807).

Also, when a signal from the image key 107b is inputted to CPU 110, CPU 110 refers to image data of the mail data which is in the non-volatile memory 102b, and decode-processes the image data, and displays, for example, as shown in FIG. 9(4), on the sub display part 104.

In FIG. 9(4), the sub operation key 107a function as the “RETURN” key, and the sub operation key 107b functions as a “STORAGE” key.

When a signal from this “RETURN” key 107a is inputted to CPU 110, CPU 110 refers again to the mail data which is in the non-volatile memory 102b, and displays, for example, as shown in FIG. 9(3), on the sub display part 104 (S809).

Also, when a signal from the “STORAGE” key 107b to a folder is inputted to CPU 110, CPU 110 refers to image data of mail data which is in the non-volatile memory 102b, and copies it in an image reserve region which is in the non-volatile memory 102b (S810). At this time, for the purpose of informing a user that storage of an image was completed, CPU 110 may display, for example, a pop-up screen as shown in FIG. 9(5) on the sub display part 104.

As above, in the past, necessary was an operation of taking the trouble to open a portable telephone and changing to the E-mail mode to thereby read a content of a received mail, but in this embodiment, by having a user select whether he/she reads a content of a mail or not right after the mail was received, the suchlike troublesome task can be omitted. Therefore, even in the closed state with limited operation keys, it is possible to read a mail content right after reception thereof, quickly and by a simple operation so that usability is very good.

In addition, since such a case that a user is unaware that a mail was received can be assumed, it may be configured that a screen (FIG. 9(2)) for having a user select whether he/she will read a content of a mail right after the mail was received is deleted after the lapse of predetermined time, and it is displayed that there was reception of a mail. By this, it is possible to reduce vain electric power consumption.

Also, it may be configured that, by opening a portable telephone, after the screen for having a user select whether the user reads a content of a mail was displayed, a body text of the mail is automatically displayed on the main display part 103. That is, it is possible to make such an arrangement that to open a portable telephone is indication of such an intention of a user that the user will read a mail. In this case, it may be configured that, in case that the opened state was detected by the fold detection part 108, after CPU 110 activated the mail function, a body text of a received mail is displayed.

Also, in the above-described embodiment, the case of receiving a mail with image information attached hereto was described, but it is not limited to this, and it may be configured to receive a mail which does not have image information attached.

In this case, processing regarding image information attached, i.e., processes of S807 to S810 are to be omitted. In addition, FIGS. 9(6) to 9(8) are display screen examples in that case. By this, even in case that a mail with no image information attached was received, it is possible to read a mail content right after reception in a state that a portable telephone was closed.

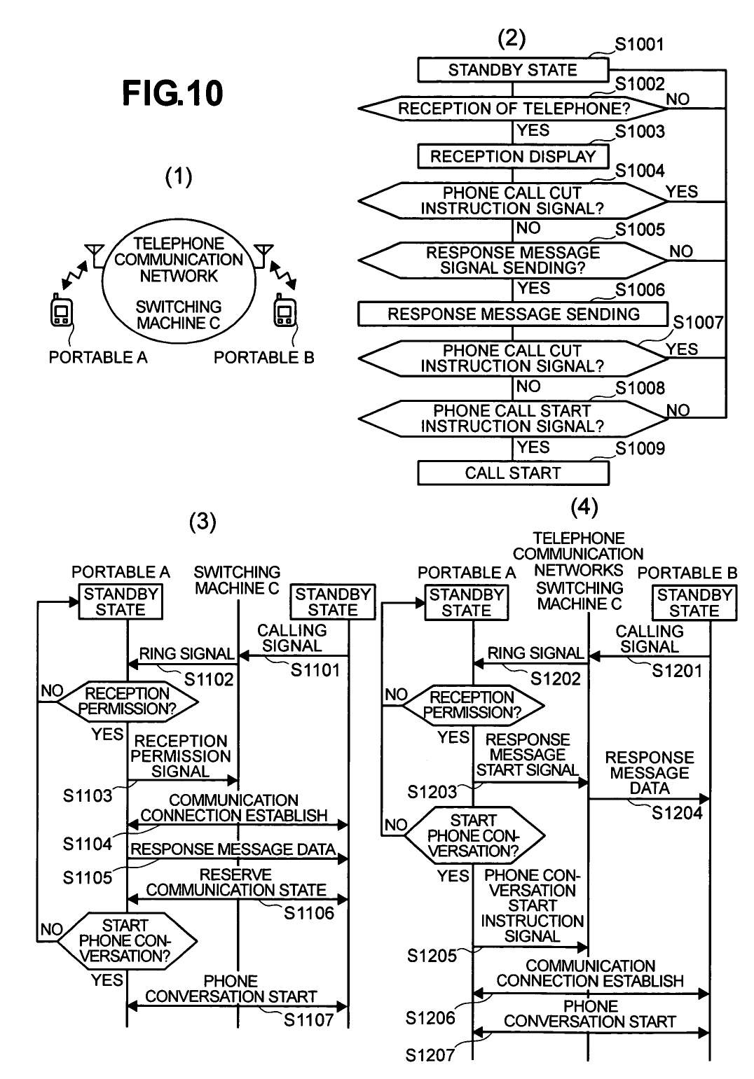

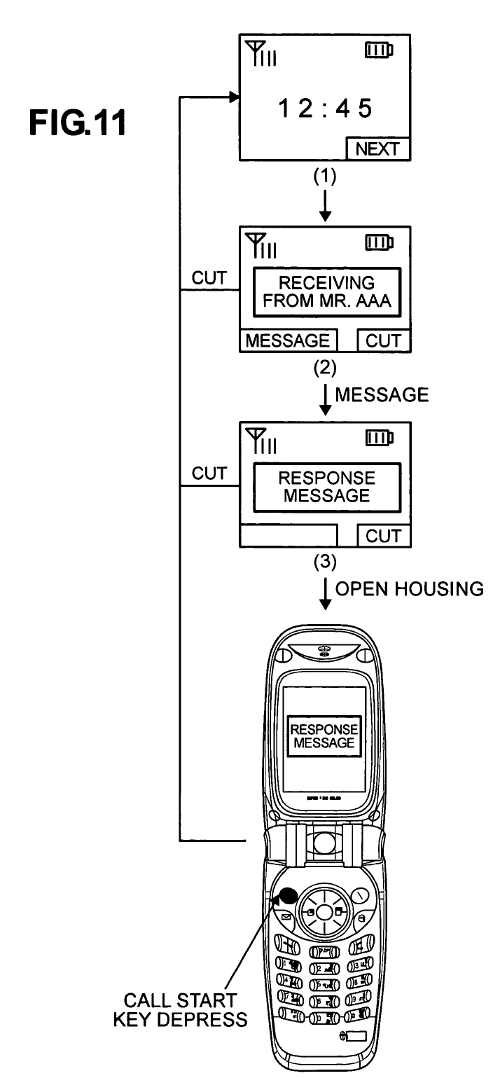

Next, a fourth embodiment will be described by use of a flow chart of FIG. 10 and a display screen example of FIG. 11. Here, such an embodiment that, in case that there was reception of a telephone in the state that a portable telephone was closed, a user can start a telephone call at ease, will be described.

FIG. 10(1) is a view showing an entire system which included a portable telephone (PORTABLE A) of a user A, a portable telephone (PORTABLE B) of a user B, and a switching machine C. FIG. 10(2) is a process flow chart of PORTABLE A in this embodiment, and FIG. 10(3) is a process flow chart in an entire system.

For example, in a standby state in which an idle screen as shown in FIG. 11(1) is displayed (S1001), the switching machine C which received (S1101) a calling signal that was sent from PORTABLE B sends a ring signal for calling out PORTABLE A to PORTALBE A (S1102).

CPU 110 of PORTABLE A which received the ring signal analyses a telephone number and so on of PORTABLE B from the ring signal, and searches address book data which was in the non-volatile memory 102b by use of the telephone number as a search key, and displays, for example, as shown in FIG. 11(2), name information which corresponds to the search key, on the sub display part 104, and informs a user that there is an incoming call (S1003). Here, in case that there is no name information which corresponds to the search key, in the address book data, CPU 110 displays a telephone number of PORTABLE B.

In FIG. 11(2), the sub operation key 107a functions as a “MESSAGE” key, and the sub operation key 107b functions as a “CUT” key.

When a signal from this cut key 107b is inputted to CPU 110, CPU 110 sends a cut signal to the switching machine C through the communication part 101, and reject reception and returns to the standby state (S1001), and displays, for example, an idle screen as shown in FIG. 11(1) on the sub display part 104 (S1004).

Also, when a signal from the message key 107a is inputted to CPU 110 (S1005), CPU 110 sends a reception permission signal to the switching machine C through the communication part 101 (S1103), and connects a telephone call line (S1104). Next, CPU 110 refers to response message data which was stored in the non-volatile memory 102b and sends a response message of for example, “Since I will answer soon, please hang on for a while.” and so on to PORTABLE B through the communication part 101 and the switching machine C (S1006) (S1105). At this time, in order to inform a user of flowing a response message on PORTABLE B, CPU 110 displays, for example, a pop-up screen as shown in FIG. 11(3), on the sub display part 104 to hold a telephone call state (S1106).

At this time, for the purpose of informing a user of the middle of flowing a response message to a calling person, it may be configured to display, for example, a pop-up screen as shown in FIG. 11(4), on the main display part 103.

In FIG. 11(3), the sub operation key 107b functions as the cut key. When a signal from this cut key 107b is inputted to CPU 110, CPU 110 sends a cut signal to the switching machine C through the communication part 101, and finishes the telephone call and returns to the standby state, and displays, for example, an idle screen as shown in FIG. 11(1) on the sub display part 104 (S1007).

After the response message was sent to PORTABLE B (S1006), PORTABLE A is opened, and when a telephone call start key (FIG. 11(4)) of the main operation key 106 is depressed, a telephone call start instruction signal from the telephone call start key is inputted to CPU 110 (S1008), CPU 110 stops sending of the response message and sends the telephone call start instruction signal (S1107), and activates the microphone 111 and a telephone call speaker 112, and switches from the telephone call state which was held in S1006 to a state that a telephone call is available (S1009) (S1108).

As above, in case that an incoming call of a telephone was received in the state that a portable telephone was closed, a response message is informed to a calling terminal for now, and after that, without panic, with additional time, a user can start a telephone call with a calling person so that usability is good.

Also, since a user can send a response message by a simple operation such as depressing the sub operation key 107a (message key), it is possible to quickly convey an intention to answer a telephone call to a calling person, and a calling person can wait for start of a telephone call at ease.

In addition, in case that time which passed from sending of a response message to a calling terminal until a start of a telephone call exceeded setting time (hereinafter, referred to as response elapsed time) which was set in advance, alert for starting a telephone call may be applied to a user. In this case, when a signal from the message key 107a is inputted to CPU 110 (S1005), CPU 110 activates a timer function, and starts counting of elapsed time. After that, it refers to setting time which was stored in advance in the non-volatile memory 102b, and in case that the elapsed time exceeded the setting time, CPU 110 outputs a sound signal for alerting which was stored in advance in the non-volatile memory 102a to the music speaker 113. By this, for example, even in case that a user is unaware that the user pushed the message key 107a at the time of telephone call reception, since it is possible to urge a user to start a telephone call by alert means such as an alert sound and so on, it is possible to prevent a calling person from being left in a state that the calling person listened the response message as it is.

In addition, the alert means is not limited to the above-described embodiment, but for example, characters or colors for alert may be displayed on the sub display part 104, and a user is urged to start a telephone call by combination of alert sounds, characters and color information, and it may be configured to have a user selected a type of alert sounds and display characters.

Also, in a portable telephone which has an answer phone function for sending a message to a calling person in case that a called person can not answer the telephone call, in case that response elapsed time exceeded time for starting activation of the answer phone function (hereinafter, referred to as answer phone setting time), the answer phone function is automatically activated, and therefore, it is impossible to start a telephone call. On that account, it may be configured to stop the answer phone function, in case that the message key 107a was depressed.

In this case, when a signal from the message key 107a is inputted to CPU 110 (S1005), CPU 110 activates the timer function, and starts counting of elapsed time. After that, CPU 110 is designed to refers to the answer phone setting time which was stored in advance in the non-volatile memory 102b, and not to carry out processing for sending an answer phone reproduction instruction signal for instructing reproduction of an answer phone, to a telephone communication line, for example, to an answer phone message service center, even if the response elapsed time passed over the answer phone setting time.

By this, even if the response elapsed time passed over the answer phone setting time, the answer phone function is not activated, and therefore, a user, without panic, opens a portable telephone, and can carry out an operation of starting a telephone call.

In addition, in the above-described embodiment, it was configured that the answer phone function itself is stopped in case that the response elapsed time passed over the answer phone setting time, but it may be configured to automatically extend the answer phone setting time.

In this case, when a signal from the message key 107a is inputted to CPU 110 (S1005), CPU 110 activates the timer function, and starts counting of elapsed time, and after that, CPU 110 processes to change for extending the answer phone setting time (e.g., 15 seconds) which was stored in advance in the non-volatile memory 102b by a predetermined preset value (e.g., 30 seconds).

By this, even if the response elapsed time passed over the answer phone setting time, since the answer phone function is not activated for a certain amount of time (here, 30 seconds), a user can open a portable telephone without panic, and carries out an operation for starting a telephone call.

In addition, it is needless to say that it may be configured that the answer phone setting time and the extension preset value which was stored in the non-volatile memory 102b can be changed by a user.

The answer phone message service center which received the message reproduction instruction signal sends a message signal to a calling terminal. CPU of the calling terminal which received the message signal outputs the message signal to a telephone call speaker and so on, and informs a calling person of the message.

In addition, in the above-described embodiment, it was configured that, after the message key 107a was depressed, in the state that a portable telephone was opened, for example, as shown in FIG. 11(4), the telephone call start key was depressed to start the telephone call (S1009), but since to depress the message key 107a is also an indication of such intention that a user will answer the call later, to depress the telephone call start key again in the opened state becomes a double troublesome task.

In this connection, it may be configured that, after the message key 107a was depressed in the closed state, if a portable telephone is opened, a telephone call is automatically started.

In this case, if a portable telephone is left in the opened state, the opened and closed state information which was stored in the volatile memory 102a is changed from the closed state “1” to the opened state “0”, and CPU 110 which recognized that change, stops sending of a response message, and activates the microphone 111 and the telephone call speaker 112, and carries out processing for restarting the telephone call state which was held in S1006.

By this, since a troublesome task for taking the trouble to depress the telephone call start key can be omitted, usability is good.

Also, it may be configured that the telephone communication network, for example, the switching machine sends a response message which was sent in S1006. In this case, in the standby state (S1001) in which, an idle screen as for example, shown in FIG. 11(1) is displayed, the switching machine C which received (S1201) a calling signal which was sent from PORTABLE B sends a ring signal for calling out PORTABLE A to PORTABLE A (S1202).

CPU 110 of PORTABLE A which received the ring signal analyses a telephone number and so on of PORTABLE B from the ring signal, and searches address book data which was in the non-volatile memory 102b by use of the telephone number as a search key, and displays, for example, as shown in FIG. 11(2), name information which corresponds to the search key, on the sub display part 104, and informs a user that there is an incoming call (S1003). Here, in case that there is no name information which corresponds to the search key, in the address book data, CPU 110 displays a telephone number of PORTABLE B.

In FIG. 11(2), the sub operation key 107a functions as a “MESSAGE” key, and the sub operation key 107b functions as a “CUT” key.

When a signal from this cut key 107b is inputted to CPU 110, CPU 110 sends a cut signal to the switching machine C through the communication part 101, and reject reception and returns to the standby state (S1001), and displays, for example, an idle screen as shown in FIG. 11(1) on the sub display part 104 (S1004).

Also, when a signal from the message key 107a is inputted to CPU 110 (S1005), CPU 110 sends a response message start signal to the switching machine C through the communication part 101 (S1104) (S1203). Next, the switching machine C sends a response message of for example, “Since I will answer soon, please hang on for a while. ” and so on to PORTABLE B through the communication part 101 and the switching machine C (S1006) (S1204). At this time, in order to inform a user of flowing a response message on PORTABLE B, CPU 110 displays, for example, a pop-up screen as shown in FIG. 11(3), on the sub display part 104. At this time, communication may be or may not be established between PORTABLE A and PORTABLE B, but since a wireless resource is finite, use efficiency of the wireless resource is better in case that communication is not established between PORTABLE A and PORTABLE

In FIG. 11(3), the sub operation key 107b functions as the cut key. When a signal from this cut key 107b is inputted to CPU 110, CPU 110 sends a cut signal to the switching machine C through the communication part 101, and finishes the sending of the response message from the switching machine C to PORTABLE B, and PORTABLE A returns to the standby state, and displays, for example, an idle screen as shown in FIG. 11(1) on the sub display part 104 (S1007).

After the response message start signal was sent to the switching machine C (S1203), PORTABLE A is opened, and when the telephone call start key (FIG. 11(4)) of the main operation key 106 is depressed, a telephone call start instruction signal from the telephone call start key is inputted to CPU 110 (S1008), CPU 110 sends the telephone call start instruction signal to the switching machine C (S1205), and establishes a communication connection with PORTABLE B (S1206), and activates the microphone 111 and a telephone call speaker 112, and sets to a state that a telephone call is available (S1009) (S1207).

By the foregoing, since the switching machine is configured to send the response message, burdens of a memory and processing of a portable telephone are reduced.

As above, mail reception and telephone call reception in the closed state was described, but it is needless to say that a key layout, a display screen and so on are not limited to this embodiment. Also, as to a point that a message is displayed at the time of mail reception, and on the basis of that message, browsing of mails are inquired, and a point that, on the basis of a result of that inquiry, a body text of a mail is automatically displayed, it is needless to say that they are applicable not only to a fold type portable telephone but also to other portable telephone.

Also, in the embodiments which were described so far, as a method for returning to a previous screen of the display screen which is displayed on the sub display part 104, for example, the “RETURN ” function was assigned to any one of the sub operation keys 107a and 107b, but it may be configured that a “RETURN” exclusive use operation key is separately disposed at a place where it can be operated even in case of the state that a portable telephone was closed, and in case that it was depressed, it returns to the previous screen.

Also, in the embodiment, as a display part, a liquid crystal is considered, but it is not limited to this, and for example, it may be a display part which used a light emitting device such as an organic EL and so on.

Also, the invention is not limited to the embodiments which were shown as above, and a principle and a new characteristic which were disclosed here include a broad range of a technical scope.

As above, according to this invention, it is possible to improve usability at the time of mail reception or at the time of telephone call reception. In particular, it is possible to realize effective utilization of a sub liquid crystal at the time of mail reception or at the time of telephone call reception.

We claim:

1. A portable terminal in which a first housing and a second housing, each of which has a front surface and a back surface which is disposed so as to be opposed to the front surface, are foldable through a hinge part, and are foldable in such a manner that the front surface of the first housing and the front surface of the second housing face to each other, comprising:
a display part which is located on the back surface of the first or the second housing; and
a control part which controls to switch a screen display of the display part in case that a predetermined signal has been received.

2. The portable terminal as set forth in claim 1, wherein, in case that, supposing that the predetermined signal is an incoming signal regarding a mail, a display is switched to a screen display in which a display of a mail body text can be requested, and the display of the mail body text has been requested through the screen display, the control part controls so as to display the mail body text on the display part.

3. The portable terminal as set forth in claim 1, wherein in case that, supposing that the predetermined signal is an incoming signal regarding a telephone, a display is switched to a screen display in which a display of a mail body text can be requested, and the display of the mail body text has been requested through the screen display, the control part controls so as to send a predetermined message to a sender.

4. A portable terminal in which a first housing and a second housing, each of which has a front surface and a back surface which is disposed so as to be opposed to the front surface, are foldable through a hinge part, and are foldable in such a manner that the front surface of the first housing and the front surface of the second housing face to each other, comprising:
a display part which is located on the back surface of the first or the second housing; and
a control part which controls to output a screen which has a user select whether a content of a mail is displayed or not, in case that a signal regarding a mail has been received.

5. The portable terminal as set forth in claim 2, wherein the control part controls to automatically display a content of a mail on the display part which is located on the front surface of the first or the second housing, in case that it has gone into a state that the portable terminal has been opened after a display of the content of the mail was requested.

6. A portable terminal in which a first housing and a second housing, each of which has a front surface and a back surface which is disposed so as to be opposed to the front surface, are foldable through a hinge part, and are foldable in such a manner that the front surface of the first housing and the front surface of the second housing face to each other, comprising:
a display part which is located on the back surface of the first or the second housing;
a selection part which selects whether a predetermined notification is supplied to a sender or not in case that an incoming signal regarding a telephone has been received; and
a control part which controls to automatically start a telephone call, in case that it has gone into a state that the portable terminal has been opened after to carry out the predetermined notification is selected by the selection part.

7. A portable terminal comprising:
a reception part which receives information regarding a mail;
a display part which displays the information regarding a mail which has been received by the reception part; and
a control part which controls to display a screen for having a user select whether or not the information regarding a mail is displayed on the display part when the information regarding a mail has been received.
